(19) United States
(12) Patent Application Publication
(10) Pub. No.: US 2025/0086709 A1
(43) Pub. Date: Mar. 13, 2025

(54) SYSTEM AND METHOD FOR CREATING FINANCIAL SOLUTIONS CUSTOMIZED TO CUSTOMER FINANCIAL NEEDS

(71) Applicant: Aveek Kumar Mukherjee, Bangalore (IN)

(72) Inventor: Aveek Kumar Mukherjee, Bangalore (IN)

(21) Appl. No.: 18/960,446

(22) Filed: Nov. 26, 2024

Related U.S. Application Data
(63) Continuation-in-part of application No. 17/830,539, filed on Jun. 2, 2022.

(30) Foreign Application Priority Data
Apr. 28, 2022 (IN) 202241024616

(51) Int. Cl. G06Q 40/03

(52) U.S. Cl. CPC G06Q 40/03

(57) ABSTRACT

A system and method for optimizing spends of a customer are disclosed. The system includes a processor that is configured to receive financial data associated with a customer, perform an analysis of one or more interest rates associated with the customer, perform an analysis of a risk profile associated with the customer, and analyse a relationship between the customer and respective bank over a threshold time period. The processor is further configured to determine a spend optimization suggestion for the customer based on the one or more interest rates analysis, the risk profile analysis, the relationship analysis, and a current financial situation of the customer. In addition, the processor displays the spend optimization suggestion to the customer on their respective device.

### CROSS REFERENCE TO PRIOR APPLICATION

This application is a Continuation-In-Part of U.S. patent application Ser. No. 17/830,539, entitled as SYSTEM AND METHOD FOR CREATING FINANCIAL SOLUTIONS CUSTOMIZED TO CUSTOMER FINANCIAL NEEDS, filed Jun. 2, 2022, which claimed priority to Indian patent application Ser. No. 20/224,1024616, filed Apr. 28, 2022, both of which are incorporated by reference in their entirety.

### FIELD OF THE INVENTION

This disclosure relates to the field of banking and financial services. More specifically, the field relates to a system and method for creating financial solutions customized to the unique needs of each customer based on analysis of their current product sets, asset-liability & income-expense mix, cash inflows and outflows, social behaviors, current-future financial commitments, risk profile, and relationship with the bank over a period of time. For the banking and financial services industry, simplification is key for both customers and banks. Getting an aggregated view across all the financial activities of the customer, aggregating the risk levels across the same, and eventually offering a customized solution for their entire financial needs. Focus here is about the holistic relationship and not a siloed product-based approach which happens today.

### BACKGROUND

The background information herein below relates to the present disclosure but is not necessarily prior art.

The percentage of people opening bank accounts and relying on banks for providing services such as loans, credit card, cheque payments, and the like, has significantly increased over the past decade. Thus, it is important that banks provide best services and maintain strong relationships with their customers. However, banking and financial services sometimes may be complicated for customers to understand. Banks make considerable money, but customers may not be happy. Banks lend out money between 3%-10%, charge various fees (such as customer fee, transaction fee, service fee, interchange fees, overdraft fee), and pay only around 0.25% as a return on savings. While some bank customers may not be satisfied due to these factors, there is a large population that cannot afford some of the financial services. As a result, banks may not be able to meet the needs and demands of a significantly large population.

Also, some bank customers may not know how to choose the right products to fit their needs, such that they can optimize the charges and fees they pay to the bank(s). Furthermore, customers want to be treated differently based on the business they provide to the banks. So, as they bring more business to the bank, the bank needs to give them better interest rates/fees, services. This requires banks to uniquely customize a financial solution to cater to the customer's needs, which is quite difficult with the current baking offerings.

Thus, there is a need for a solution in which a customer's financial portfolio may be duly aggregated for analyzing risk vs profitability at an individual customer level, in order to deliver a best option for meeting their financial needs and demands.

Analyzing the entire portfolio is key, data from existing systems, existing products, also bringing risk parameters is key, it's a data driven risk optimized relationship building platform.

### SUMMARY

The present disclosure discloses a system including a memory and a processor coupled to the memory. The processor is configured to receive financial data associated with a customer, perform an analysis of one or more interest rates associated with the customer, perform an analysis of a risk profile associated with the customer, and analyse a relationship between the customer and respective bank over a threshold time period. The processor is further configured to provide suggestions on how the customer may optimize the earnings/spends with respect to their financial transactions based on the one or more interest rates analysis, the risk profile analysis, the relationship analysis, and a current financial situation of the customer. The determined earnings/spend optimization suggestion is then displayed to the customer.

The risk parameters can be fined tuned for every customer and not be a generic approach. Also, looking at the entire relationship which is key, the platform aggregates the existing data and also brings in new external 3rd party data to further enhance the value of understanding the customer needs and serving them for their needs and not what products the banks want to sell to them. Banks efficiency ratios are over the top and by bringing all this together, helps the banks to potentially reduce the number of paid products they offer today. Thus, reducing the number of products serviced by the bank, and reducing the cost of operations and headcount for the banks.

In accordance with the aspects of the disclosure, the one or more interest rates analysed includes at least one of a liquid interest rate, a secured credit interest rate, an unsecured credit interest, a term interest, and combination thereof. The processor is further configured to present the one or more interest rates analysed to the customer using rate curves. The interest rates need to look into the entire relationship of the customer and not be siloed by product.

In accordance with the aspects of the disclosure, the processor is further configured to periodically update the one or more interest rates analysed based on changes in market rates, a credit risk of the customer, financial data associated with the customer, asset-liability situation and the cash inflow-outflow patterns of the customer. Risk analysis could be done on regular intervals.

In accordance with the aspects of the disclosure, the risk profile analysed includes at least one of a credit risk profile, an asset coverage ratio (ACR) threshold, an income coverage ratio, and a customer credit position. The processor is further configured to present the risk profile analysed to the customer using graph curves. All the parameters are key for providing individual rates based on the entire risk of the customer relationship, all data is made available to the bank operator and the customer through dashboards supported by web and mobile web.

In accordance with the aspects of the disclosure, the risk profile analysed is periodically updated based on financial information related to the customer, financial transactions performed by the customer, changes in assets and liabilities associated with the customer, and external information associated with the customer. This refresh can also be performed on demand in case of any significant change in customer information or transactions.

In accordance with the aspects of the disclosure, the processor is further configured to determine one or more charges associated with the customer; perform an analysis of the one or more charges. The one or more charges analysed comprise at least one of liquidity charges, loan charges, revolving credit charges, cashflow restructure charges, and a combination thereof; and present the one or more charges analysed to the customer using rates and charges & fee curves. It helps identify the entire relationship and not just a single product or transaction.

In accordance with the aspects of the disclosure, the threshold time period is five to ten years, as may be defined by the bank.

The present disclosure also discloses a method. The method includes receiving financial data associated with a customer (including 3^{rd} data from social feeds and other data aggregator), perform an analysis of a risk profile associated with the customer, performing an analysis of one or more interest rates associated with the customer, and analysing a relationship between the customer and respective bank over a threshold time period. The method further includes determining an earnings-spend optimization suggestion for the customer based on the one or more interest rates analysis, the risk profile analysis, the relationship analysis, and a current financial situation of the customer. In addition, the method includes displaying the spend optimization suggestion to the customer.

In accordance with the aspects of the disclosure, the one or more interest rates analysed includes at least one of a liquid interest rate, a secured credit interest rate, an unsecured credit interest, a term interest, and a combination thereof. The method further comprises presenting one or more interest rates analysed to the customer using rate curves. This allows the bank to segment a loan based as a secured loan based on one or more collaterals versus an un-secured loan.

In accordance with the aspects of the disclosure, the risk profile analysed includes at least one of a credit risk profile, an asset coverage ratio (ACR) threshold, an income coverage ratio, and a customer credit position. The method further includes presenting the risk profile analysed to the customer using graph curves. This provides full transparency to the customer and also highlights ways for them to optimize their financial earning-spends, if required.

In accordance with the aspects of the disclosure, the financial transactions of the customer are broken down into a series of future cash inflows and outflows with associated rules and business logic. This method allows the bank and the customer ability to customize the transactions in a way that best suits the financial needs of the customer.

The present disclosure also discloses a non-transitory computer-readable storage medium storing one or more sequences of instructions, which when executed by the processor, causes receiving financial data associated with a customer (including 3rd data from social feeds, like Facebook, LinkedIn, etc., and other data aggregator), performing an analysis of one or more interest rates associated with the customer, perform an analysis of a risk profile associated with the customer, analysing a relationship between the customer and respective bank over a threshold time period, determining an earnings-spend optimization suggestion for the customer based on the one or more interest rates analysis, the risk profile analysis, the relationship analysis, and a current financial situation of the customer; and displaying the earnings-spend optimization suggestion to the customer.

An exemplary embodiment is a system for providing a customized financial solution, including a server configured to receive financial data associated with a customer, a network communicatively coupling a client device to the server, and the server comprising a processor and a memory. The memory stores computer-executable instructions that, when executed, cause the processor to receive a request to optimize a transactional action, receive client device details from the client device, generate a client analysis module based on the request and client device details, and transmit the client analysis module to the client device. The client analysis module causes the client device to analyze one or more interest rates associated with the customer using the financial data, analyze a risk profile associated with the customer, determine a spend optimization suggestion for the customer based on at least one of the interest rate analysis, the risk profile analysis, and the current financial situation of the customer, and display the spend optimization suggestion to the customer. The instructions may also cause the processor to generate a feedback module, configured to store client data generated subsequent to its creation, transmit the stored data to the server, and receive modification instructions based on the client data to update modules on the client device. The server may analyze the relationship between the customer and a respective bank over a threshold time period, determined by customer behavior, account type, and preferences. The processor may adjust the spend optimization suggestion using real-time updates from external financial data sources, including market interest rates, customer transactions, and macroeconomic indicators, and provide periodic re-evaluations. The processor may further determine a new need of the customer based on interest rate analysis, risk profile analysis, relationship analysis, and the customer's current financial situation.

Another general aspect is a method for providing a customized financial solution, including receiving a request from a customer to optimize a transactional action, receiving client device details, generating a client analysis module based on the request and client device details, and transmitting the client analysis module to the client device. The client analysis module causes the client device to analyze one or more interest rates associated with the customer, analyze the customer's risk profile, determine a spend optimization suggestion for the customer based on interest rate analysis, risk profile analysis, and the customer's current financial situation, and display the suggestion to the customer. The method may further include generating a feedback module configured to store client data generated after its creation, transmit this data to the server, and receive modification instructions to update client device modules. It may also involve analyzing the relationship between the customer and a respective bank over a threshold time period, determined by customer behavior, account type, and preferences. Additional steps may include adjusting the spend optimization suggestion using real-time updates from external financial data sources, such as market interest rates, customer transactions, and macroeconomic indicators, and providing periodic re-evaluations of the suggestion.

An exemplary embodiment is a computer-readable storage medium containing instructions that, when executed, cause the medium to perform steps including receiving a request from a customer to optimize a transactional action, receiving client device details, generating a client analysis module based on the request and client device details, and transmitting the client analysis module to the client device. The client analysis module causes the client device to analyze one or more interest rates associated with the customer, analyze the customer's risk profile, determine a spend optimization suggestion for the customer based on interest rate analysis, risk profile analysis, and the customer's current financial situation, and display the suggestion to the customer. The instructions may also cause the medium to generate a feedback module configured to store client data generated after its creation, transmit this data to the server, and receive modification instructions to update client device modules. Additional functionality includes adjusting the spend optimization suggestion using real-time updates from external financial data sources, including market interest rates, customer transactions, and macroeconomic indicators, while providing periodic re-evaluations of the suggestion.

### BRIEF DESCRIPTION OF THE DRAWINGS

FIG. 1 illustrates a block diagram of the components of the system, in accordance with an embodiment of the present disclosure;

FIG. 2 illustrates a customer setup screen in which the customer enters their financial data, in accordance with an embodiment of the present disclosure;

FIG. 3 illustrates an interest rate screen in which one or more interest rates analyzed are presented to the customer, in accordance with an embodiment of the present disclosure;

FIG. 4 illustrates a risk profile screen in which risk profiles analyzed are presented to the customer, in accordance with an embodiment of the present disclosure;

FIG. 5 illustrates a fees & charges screen in which one or more fees & charges analyzed are presented to the customer, in accordance with an embodiment of the present disclosure;

FIG. 6 illustrates a relationship screen in which in which a relationship between the customer and respective bank analyzed over a time period are presented to the customer, in accordance with an embodiment of the present disclosure;

FIG. 7 illustrates an earnings-spend optimization suggestion screen presented to the customer, in accordance with an embodiment of the present disclosure;

FIG. 8 illustrates an operations screen presented to the customer, in accordance with an embodiment of the present disclosure;

FIG. 9 illustrates a deposit screen presented to the customer in which the customer deposits money, in accordance with an embodiment of the present disclosure;

FIG. 10 illustrates a borrow screen presented to the customer in which the customer borrows money, in accordance with an embodiment of the present disclosure;

FIG. 11 illustrates a loan screen in which a loan schedule associated with the customer is presented, in accordance with an embodiment of the present disclosure;

FIG. 12 illustrates a collateral management screen in which collaterals associated with the customer is presented, in accordance with an embodiment of the present disclosure;

FIG. 13 illustrates an add collateral screen presented to the customer in which the customer is allowed to add and modify collaterals that they hold with the respective bank, in accordance with an embodiment of the present disclosure;

FIG. 14 illustrates a transaction screen in which a list of transactions is presented to the customer, in accordance with an embodiment of the present disclosure;

FIG. 15 illustrates a flowchart illustrating a method for determining a spend optimization suggestion for the customer, in accordance with an embodiment of the present disclosure; and

FIG. 16 illustrates a schematic of an embodiment of a computer system that may be implemented to carry out the disclosed subject matter.

FIG. 17 is a schematic of a Client Personalization Embodiment of the disclosed subject matter.

FIG. 18 is a schematic showing an embodiment of the client analysis module generator and the client analysis module interacting with a client device.

FIG. 19 is a flow diagram of the Client Personalization Embodiment of the disclosed subject matter.

### DETAILED DESCRIPTION

Embodiments, of the present disclosure, will now be described with reference to the accompanying drawing.

Embodiments are provided so as to convey the scope of the present disclosure thoroughly and fully to the person skilled in the art. Numerous details, are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, elements, modules, units and/or components, but do not forbid the presence or addition of one or more other features, elements, components, and/or groups thereof. The particular order of steps disclosed in the method and process of the present disclosure is not to be construed as necessarily requiring their performance as described or illustrated. It is also to be understood that additional or alternative steps may be employed.

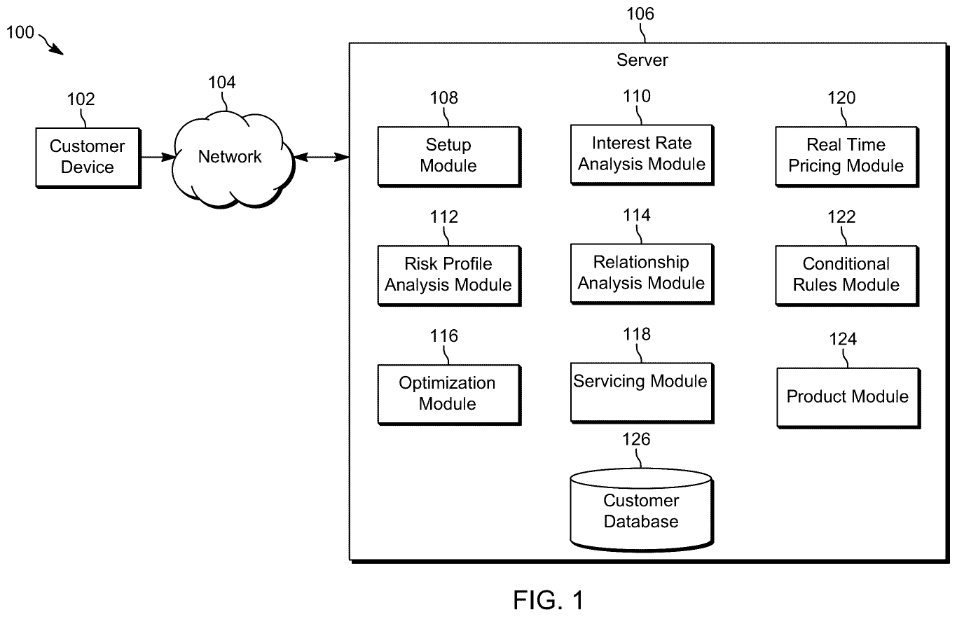

FIG. 1 illustrates a block diagram of the components of the system 100, in accordance with an embodiment of the present disclosure. As shown, the system 100 includes a customer device 102, a network 104, and a server 106. In an example, the customer device 102 may be a personal computer (PC), mobile device, smartphone, tablet, personal device assistant (PDA), and the like. The customer device 102 is communicatively coupled to the server 106 via the network 104. The server 106 includes a setup module 108, an interest rate analysis module 110, a risk profile analysis module 112, a relationship analysis module 114, an optimization module 116, a servicing module 118, a real time pricing module 120, a conditional rules module 122, a product module 124, and a customer database 126. Each module of the server 106 is described in greater detail below.

In an embodiment, the setup module 108 receives financial data associated with the customer. The financial data includes information entered by the customer at the time of registration. The financial data may be entered by the customer using the customer device 102. In various embodiments, the financial data may be entered into a bank employee device, a relationship manager device, or similar financial services computing device that is used to aid the customer; any of which may be used as the customer device 102. The financial data includes information such as an ID of the customer, name of the customer, date of birth of the customer, social security number (SSN) of the customer, current surplus income of the customer, customer segment, and an unsecured lending limit. The financial data entered by each customer is stored in the customer database 126. Further, the customer may at any point of time modify the financial details previously entered by them. These modified financial details are immediately updated and stored in the customer database 126. The customer may also consent to allow access of his/her data from social media and other public channels that may be used to understand the customer and the customer relationships better. The customer will be able to see the social influence data and the associated analysis of the data.

Liquid interest rate or liquidity refers to a degree with which an asset can be quickly bought or sold at a price close to its intrinsic/estimated value. Cash is generally considered the best liquid asset since it quickly moves in the market and can easily be converted into other assets. For instance, the interest rate analysis module 110 may determine the liquid interest rate based on ratios that measure accounting liquidity. Accounting liquidity measures an ease with which the customer can meet their financial obligations based on the liquid assets available with them, and the ability with which they can pay off debts.

Secured credit interest rate refers to situations in which customers put up an asset as collateral for any loan that they have taken. Types of secured debts may be mortgages and auto loans, in which the item being financed becomes the collateral for the financing. Unsecured credit interest rate refers to situations in which customers do not have adequate collateral to cover the borrowing of the customer. The bank may analyze the credit worthiness of the customer and provision an unsecured line to the customer that would allow for such drawdowns. The interest rate analysis module 110 analyzes the above parameters, if any, associated with the customer, and presents them on the customer device 102 using a graph curve.

Term interest rate refers to interest rates on deposits with a fixed term. For instance, the interest rate analysis module 110 first determines if any loans are outstanding for the customer, and then determines the interest for netted out surplus deposit (if any). The interest rate is determined over a period of time and presented on the customer device 102 using a graph curve.

In an embodiment, the interest rate analysis module 110 analyzes and updates the one or more interest rates in a periodic basis. The interest rates are periodically updated based on changes in market rates, a credit risk of the customer, financial data (including other third-party data) associated with the customer, an asset-liability situation of the customer, and the like. Based on the periodic updates, the graph curves for each respective interest rate measured is also updated and presented to the customer on the customer device 102 in a timely manner.

In an embodiment, the risk profile analysis module 112 performs a risk profile analysis of the customer financial profile. The risk profiles analysed are a credit risk profile, an asset coverage ratio (ACR) threshold, an income coverage ratio, and a customer credit position. Each risk profile is analysed over a period (for example 5-10 years) and presented to the customer using graph curves on the customer device 102. This is also used by the bank to determine credit decisions and to restructure outstanding debt.

Credit risk is an analysis of a risk of default on a debt that may arise when a user fails to make required payments. For instance, the risk profile analysis module 112 may determine the credit risk based on prediction of a default probability, exposure, and loss rate of the customer. The default probability is a probability that the customer will default on his/her payment, exposure is an estimation of a total amount that the bank expects to collect over the loan lifetime, and loss rate refers to an estimation in how much money the bank can lose if the customer is unable to pay the loan back in time. The risk profile analysis module 112 analyzes the credit risk of the customer based on the above parameters and presents the credit risk profile analysis using a graph curve on the customer device 102.

Income coverage ratio (ICR) threshold refers to an amount of cash inflow available with the customer to meet future debt obligations. A threshold lesser than 1 indicates a net negative cash flow situation, meaning that there is not enough income to cover debt payments. For example, the customer is projected to maintain an annual income of $36,000 in the next 5-10 years and is looking to borrow money which will have an annual debt service obligation of $30,000 during this period. The Income coverage ratio for this period would be 1.2 (36000/30000). Thus, the bank might find it risky to lend with only a 1.2 coverage. The risk profile analysis module 112 analyses the ICR threshold over time based on the customer financial data and transactions and presents the same using a graph curve on the customer device 102.

Customer credit position provides a snapshot of the different credit lines that the bank has extended to the customer and the extent to which these lines have been utilized by the customer. For instance, the risk profile analysis module 112 may determine a customer credit position of the customer based on analysis of all loans and a revolving credit utilized by the customer. Loans refer to medium and long term borrowing, like those to finance a home, cars, furniture, equipment, and the like. Whereas, revolving credit refers to short term financing like credit cards, overdrafts, and the like. The risk profile analysis module 112 analyses the customer credit position over time based on the above parameters and accordingly presents the same to the user using a graph curve (bar graph).

The risk profile analysis module 112 analyzes and updates each risk profile in a periodic basis as may be determined from time to time. Each risk profile is periodically updated based on financial information related to the customer, financial transactions performed by the customer, changes in assets and liabilities associated with the customer, external information associated with the customer, and the like. The risk profiles may be further periodically updated based on social information, legal/criminal information, employment information, and the like related to the customer. Based on the periodic updates, the graph curves for each respective risk profile analysed is also updated and presented to the customer on the customer device 102 in a timely manner. The consolidation allows the risk profile analysis module 112 to create a holistic view of every individual customer and will scale to cover all the customers of the bank.

In an embodiment, the relationship analysis module 114 analyses a relationship between the customer and respective bank over a threshold time period. The threshold time is generally five to ten years. The relationship analysis module 114 analyses factors such as assets, liabilities, a collateral value, borrowing limits, charges, and interest rates associated with the customer. These factors are presented on the customer device 102 using both values and graph curves.

Under assets, the relationship analysis module 114 analyses liquid deposits and term deposits associated with the customer. Liquid deposits are deposits that can easily be turned into cash while term deposits are time bound. An example of a term deposit is Certificate of Deposit, fixed term deposits, and the like. For example, in traditional banking parlance, if the customer has $5,000 in a checking account and $10,000 in a savings account, then the total liquid asset of the customer is $15,000, which can be accessed at any time. The relationship analysis module 114 obtains liquid and term deposits of the customer over the last 5 years, sums each up, and presents the summation of each deposit on the customer device 102.

Under liabilities, the relationship analysis module 114 analyses loans and revolving credit associated with the user. The relationship analysis module 114 obtains each active loan taken by the customer, sums up the total loan amount outstanding, and presents the amount on the customer device 102. Further, revolving credits is a type of credit that enables a user to borrow money on-demand up to a limit while repaying in part or in full at regular intervals. The relationship analysis module 114 determines a total revolving credit of the customer and presents the same on the customer device 102.

Under collateral values, the relationship analysis module 114 analyses the market value of the customer collaterals with the bank. The collateral assets may be linked to specific loans availed by the customer. For example, if the customer has borrowed money to finance a car or an equipment which qualifies to be an operating lease as per accounting/tax rules, the asset would be in the name of the bank and the depreciation from that asset would benefit the bank. Similarly, the loan to buy a house may be linked to the specific home as collateral asset due to regulatory requirements and appropriate benefits for the customer as per prevailing tax and/or state/federal programs. The relationship analysis module 114 analyzes the collateral values of the customer based on the above parameters and presents the same on the customer device 102.

Under borrowing limits, the relationship analysis module 114 analyses secured limits and unsecured limits associated with the customer. Secured limits are arrived at by analyzing the credit assessment of the customer along with the collaterals that they have with the bank. Unsecured limits are solely based on the credit assessment of the customer. The relationship analysis module 114 analyzes the respective limits of the customer and presents the same on the customer device 102.

Under charges, the relationship analysis module 114 analyses multiple factors like profitability of the customer, amount of business that the customer brings to the bank, projected future business potential from the customer, risk outlook for the customer, and the like. By performing the analysis from time to time, the bank is able to provide the best fees and charges schedule for the customer based on their current and future financial outlook. The relationship analysis module 114 determines these respective charges and presents the same on the customer device 102.

Under interest rates, the relationship analysis module 114 analyzes a deposit percentage and a borrowing percentage associated with the customer. The deposit percentage is the interest rate paid by the bank on deposits made by the customer. The borrowing percentage is the interest rate charged by the bank for any loans taken by the customer. A similar interest rate is calculated for revolving credit usage. The relationship analysis module 114 determines these respective interest rates and presents the same on the customer device 102.

In an embodiment, the optimization module 116 determines an earnings-spend optimization suggestion for the customer and displays the optimization suggestions on the customer device 102. For instance, the optimization module 116 may use an artificial intelligence (AI) algorithm for determining optimization suggestions for the customer. The algorithm analyzes the financial transaction patterns of the customer along with internally and externally sources data, to determine opportunities that would allow the customer to increase their earnings or reduce their spends from their financial transactions. These could be in the form of better interest rates, fees & charges, total interest earns or paid, and the like. Such data are obtained by the interest rate analysis module 110, the risk profiles obtained by the risk profile analysis module 112, the customer and bank relationship analysis conducted by the relationship analysis module 114, and a current financial situation of the customer. The algorithm then suggests steps to be taken for the customer to optimize their earnings-expenditures, by structuring their financial transactions in a certain way.

The steps suggested by the optimization module 116 are presented to the customer in point format (numbering or bullet points) on the customer device 102. This makes it easier for the customer to understand and accordingly take the next banking action. Based on the spend optimization suggestion determined by the optimization module 116, the customer can accordingly perform the necessary banking action. For example, the banking actions include depositing money between accounts, borrowing money between accounts, manage collaterals with the bank, change the repayment schedule of loans, and the like. This will lead to an improved banking experience for the customer as well as an improved financial portfolio of the customer.

In an embodiment, the servicing module 118 allows the bank to service the financial holdings of the customer on a continuous basis. For example, if the customer borrows money, the servicing module 118 will remind the customer of the repayment schedule, ensure repayment happens on time, restructure repayment cashflows if required, and the like.

In an embodiment, the real time pricing module 120 performs an analysis of one or more interest rates associated with the customer. The one or more interest rates analyzed include a liquid interest rate, a secured credit interest rate, an unsecured credit interest, a term interest. Each interest rate is analysed over a period (for example 5-10 years) and presented to the customer using graph curves on the customer device 102. Further, the real time pricing module 120 may include a fees charges and limits module (not shown) that computes fees/interest charges based on product configurations.

In an embodiment, the conditional rules module 122 evaluates predefined conditions linked to customer products and cashflows, to trigger actions where applicable. For instance, all asset-liability transactions are translated to a series of cashflows in the system. The system would allow for rules to be defined at a transaction level or at an individual cashflow level. For example, a deposit transaction may contain the rule that it is to be reinvested for the same term duration once it matures. On the other hand, the cashflows of a loan may state whether they are to follow the floating rate of interest curve or the fixed rate of interest curve. One can set these rules for one cashflow and choose to cascade automatically to all cashflows in that transaction.

In an embodiment, the product module 124 creates customized product templates that can be made available to selected customers for both deposits and borrowings. For example, the bank might choose to create a custom savings product that takes requires the customer to make a certain amount of deposit every month into their account for a predetermined duration. Such a product would appear in the dropdown of “Deposit Type” in the Deposit Money screen for the select customers to choose from. Similarly, the bank may create a custom loan product for certain customer segments. This product will appear in the “purpose” dropdown of the Borrow Money screen. This functionality is achieved by using custom product templates, which include a cashflow schedule which can be setup by the bank.

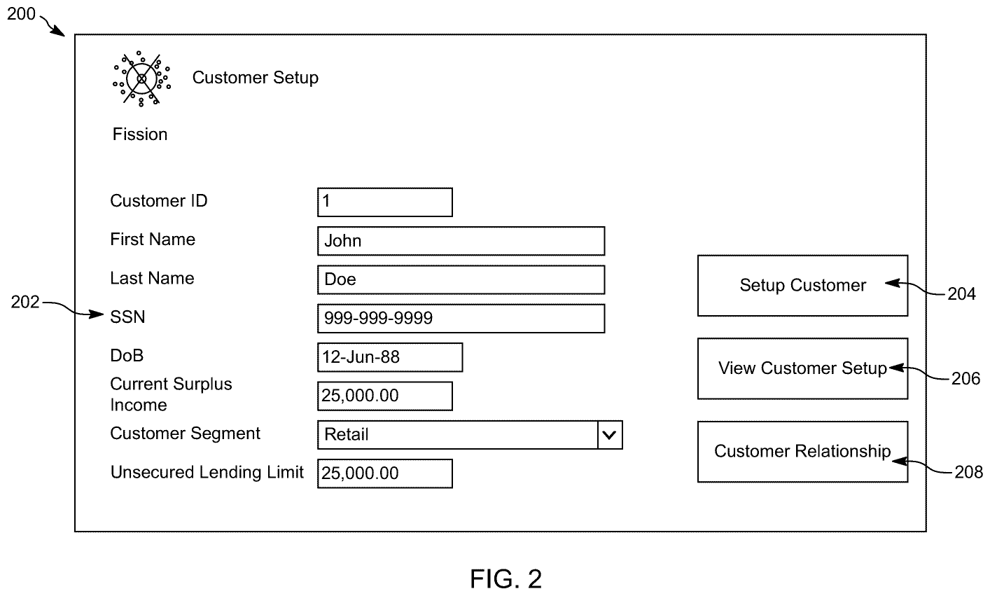

FIG. 2 illustrates a customer setup screen 200 in which the customer enters their financial data, in accordance with an embodiment of the present disclosure. The customer setup screen 200 includes an entering region 202, a setup customer button 204, a view customer setup button 206, and a customer relationship button 208, displayed on the customer device 102. Upon clicking the setup customer button 204, the entering region 202 shows up on the customer device 102. The customer enters their financial data in the entering region 202. The financial data includes information such as an ID of the customer, name of the customer, date of birth of the customer, social security number (SSN) of the customer, current surplus income of the customer, customer segment, and an unsecured lending limit. After entering the financial information in the entering region 202, the customer can click on the view customer setup button 206 for quickly viewing a summary of the details entered to check for any errors.

The financial 1 data entered by the customer is stored in the customer database 118 of FIG. 1. The customer setup allows the customer to uniquely define credit controls, interest rates and fee structure respectively. The customer may start off with some standard credit controls, interest rates and fee structure, based on the customer segment and then go for customization at an individual level. Further, the customer may at any point of time modify the financial details previously entered by them. These modified financial details are immediately updated and stored in the customer database 118. As described earlier, the customer financial setup gets periodically updated as more information emerges over time.

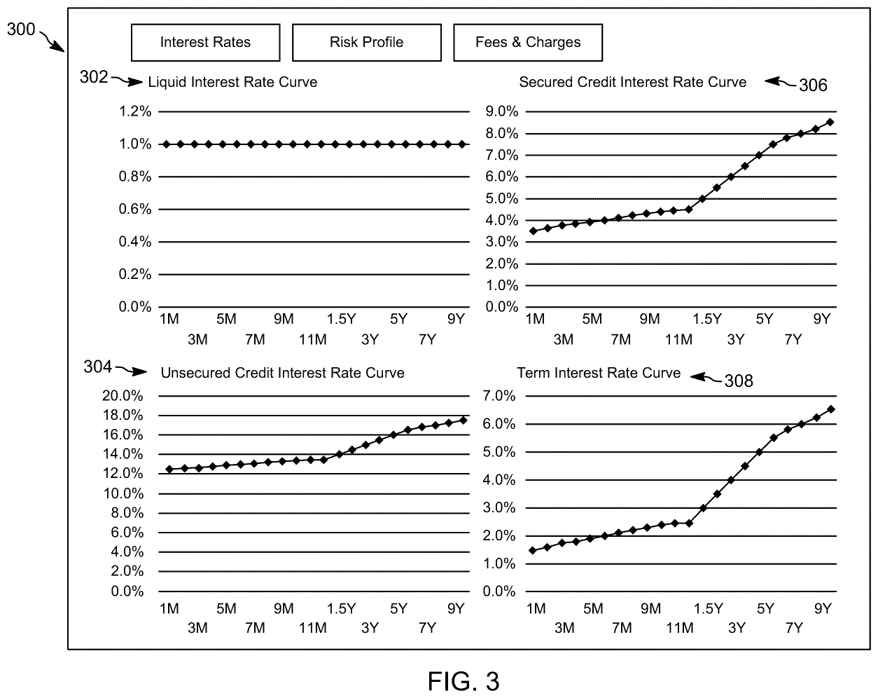

FIG. 3 illustrates an interest rate screen 300 in which one or more interest rates analyzed are presented to the customer, in accordance with an embodiment of the present disclosure. The interest rate screen 300 includes one or more interest rate graph curves analyzed by the interest rate analysis module 110. The one or more interest rate graph curves analyzed include a liquid interest rate curve 302, an unsecured credit interest curve 304, a secured credit interest curve 306, and a term interest curve 308.

Each interest rate is analyzed over a period (for example 5-10 years). The interest rate analysis module 110 analyzes and updates the one or more interest rates in a periodic basis. The interest rates are periodically updated based on changes in market rates, a credit risk of the customer, financial data associated with the customer, an asset-liability situation of the customer, and the like. Based on the periodic updates, the graph curves for each respective interest rate measured is also updated and presented to the customer on the customer device 102 in a timely manner.

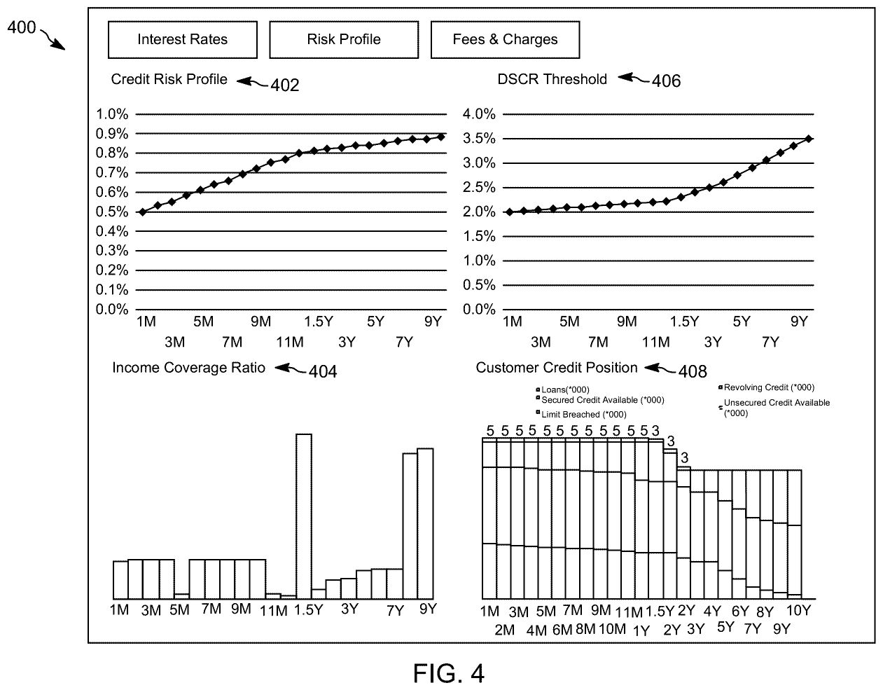

FIG. 4 illustrates a risk profile screen 400 in which risk profiles analyzed are presented to the customer, in accordance with an embodiment of the present disclosure. The risk profile screen 400 includes risk profile graph curves analyzed by the risk profile analysis module 112. The risk profiles analyzed are a credit risk profile 402, an income coverage ratio 404, an asset coverage ratio (ACR) threshold 406, and a customer credit position 408.

Each risk profile is analysed over a period (for example 5-10 years) and presented to the customer using graph curves. The credit risk profile 402 and ACR threshold 406 are presented using a line graph. The income coverage ratio 404 and customer credit position 408 are presented using bar graphs. The risk profile analysis module 112 analyzes and updates each risk profile in a periodic basis. Each risk profile is periodically updated based on financial information related to the customer, financial transactions performed by the customer, changes in assets and liabilities associated with the customer, external information associated with the customer, and the like. The risk profiles may be further periodically updated based on social information, legal/criminal information, employment information, and the like related to the customer. Based on the periodic updates, the graph curves for each respective risk profile analysed is also updated and presented to the customer on the customer device 102 in a timely manner.

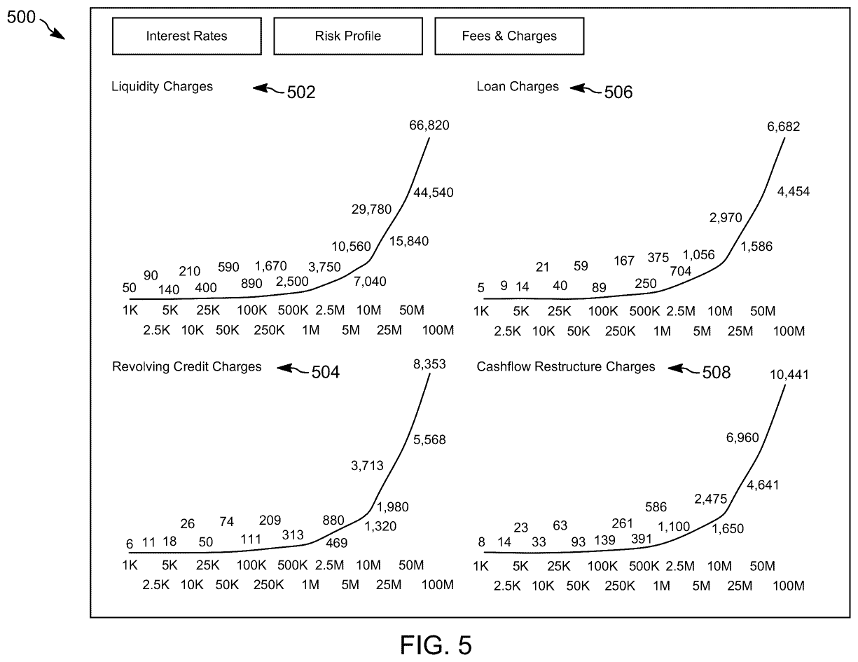

FIG. 5 illustrates a charge screen 500 in which one or more charges analyzed are presented to the customer, in accordance with an embodiment of the present disclosure. The charge screen 500 includes one or more charges associated with the customer and includes charge curves analyzed by the server 106. The charges analyzed are liquidity charges 502, revolving credit charges 504, loan charges 506, and cashflow restructure charges 508.

Each charge is analyzed over a period (for example 5-10 years). The server 106 analyzes and updates the one or more charges in a periodic basis. Based on the periodic updates, the graph curves for each respective charge analysed is also updated and presented to the customer on the customer device 102 in a timely manner.

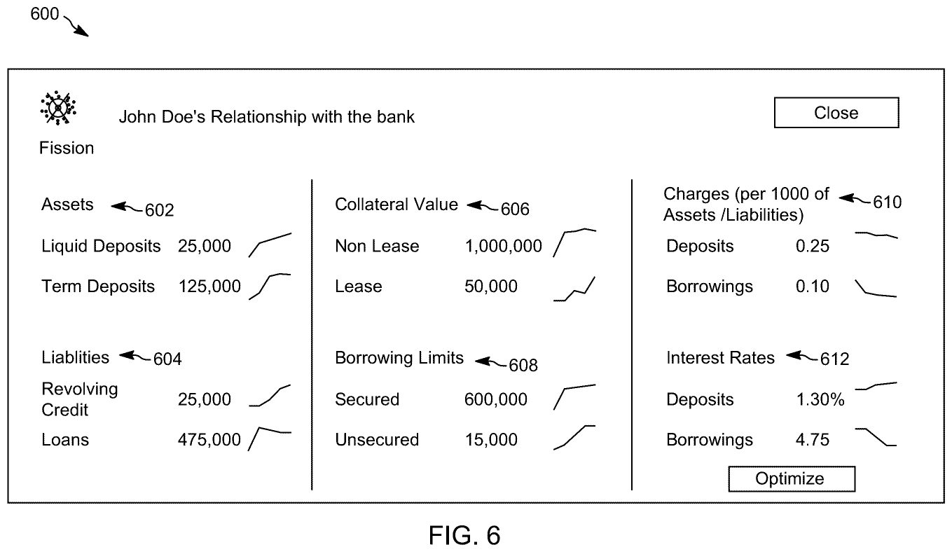

FIG. 6 illustrates a relationship screen 600 in which in which a relationship between the customer and respective bank analyzed over a time period are presented to the customer, in accordance with an embodiment of the present disclosure. The relationship screen 600 includes relationship factors analyzed between the customer and respective bank over a threshold time period. The threshold time period is generally five years. The relationship factors analyzed are assets 602, liabilities 604, a collateral value 606, borrowing limits 608, charges 610, and interest rates 612.

Under assets 602, the sub-factors analyzed are liquid deposits and term deposits. The sub-factors analysed under liabilities 604 are loans and revolving credits. The sub-factors analyzed under collateral value 606 are leases and non-leases. The sub-factors analyzed under borrowing limits 608 are secured limits and unsecured limits. The sub-factors analyzed under charges 610 are a deposit ratio and a borrowing ratio. The sub-factors analyzed under interest rates 612 are a deposit percentage and a borrowing percentage. These sub-factors are presented on the customer device 102 using both values and graph curves. These sub-factors are also updated in a periodic basis.

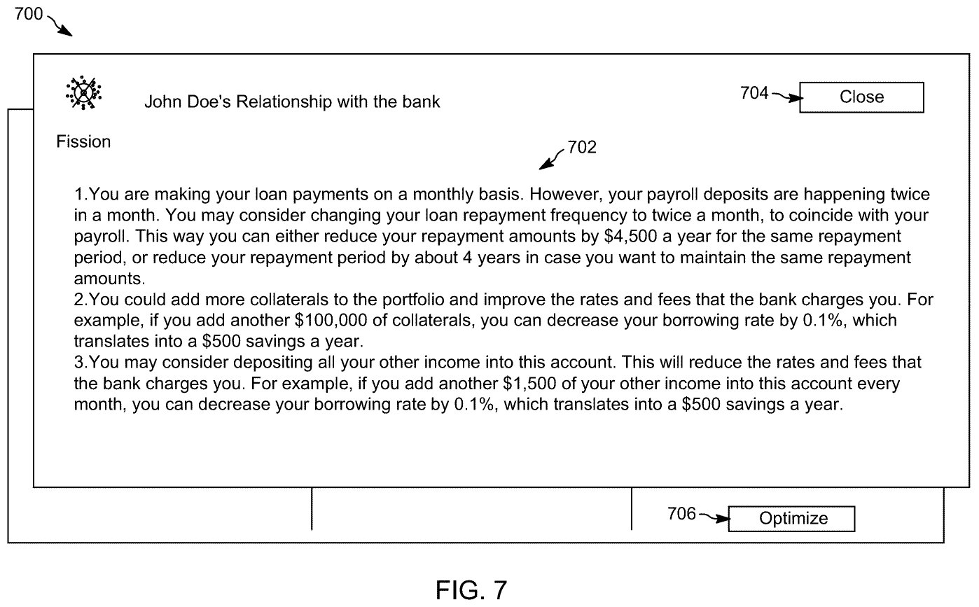

FIG. 7 illustrates a spend optimization suggestion screen 700 presented to the customer, in accordance with an embodiment of the present disclosure. The spend optimization suggestion screen 700 displays a spend optimization suggestion for the customer determined by the optimization module 116. The steps suggested by the optimization module 116 are presented to the customer in point format (numbering or bullet points) on the customer device 102. This makes it easier for the customer to understand and accordingly take the next banking action.

For instance, the first point as shown in the screen 700 suggest the customer to change his/her loan repayment frequency to twice a month. The server 106 has determined/analyzed that the customer is making loan payment on a monthly basis and payroll deposits are happening twice in a month. Changing the loan repayment frequency to twice a month enables the customer to reduce their repayment amounts by $4,500 per year or reduce their repayment period by about four years. Thus, the server 106 has suggested a good method that the customer can go for in order to save money.

The second point as shown in the screen 700 suggests the customer to add more collaterals to their financial portfolio. Addition of more collaterals improves the rates and fees that the bank charges them. The suggestion provided to the customer is to add $100,000 worth of collaterals. With this addition, the customer will be able to decrease their borrowing rate by 0.1%, thereby resulting in a savings of $500 per year.

The third point as shown in the screen 700 suggests the customer to consider depositing other income into their bank account. This will reduce rates and fees that the bank charges the customer. The suggestion provided to the customer is to add $1500 of their other income into this bank account every month. By doing so, they will be able to decrease their borrowing rate by 0.1%, thereby resulting in a savings of $500 per year.

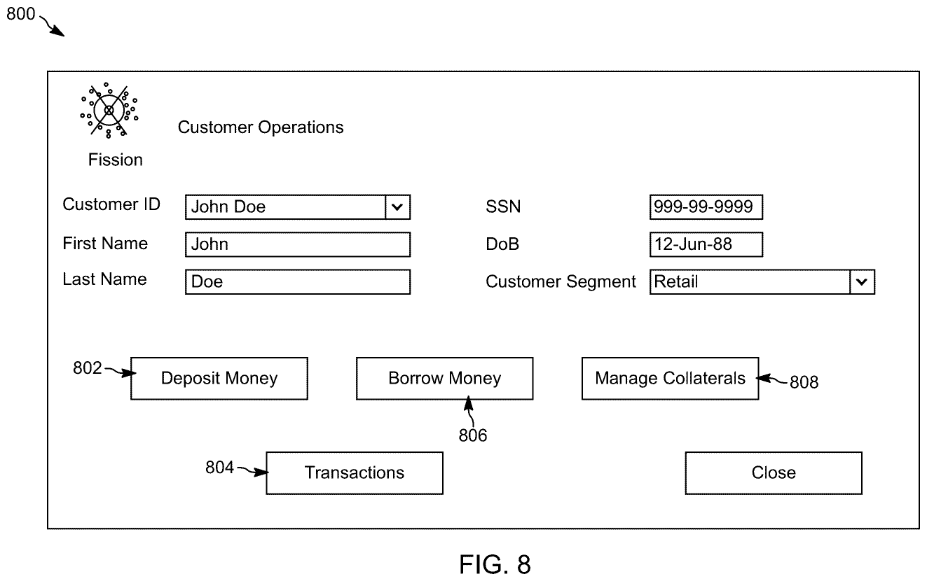

The customer may then click on the close button 704, which closes the screen 700 displayed on the customer device 102 after reading the suggestions. Based on the spend optimization suggestions displayed on the screen 700, the customer can accordingly perform the necessary banking action. For example, the banking actions include depositing money between accounts, borrowing money between accounts, and manage collaterals with the bank. This thus will lead to an improved banking experience for the customer as well as an improved financial portfolio of the customer. The banking actions are depicted and described in FIGS. 8-14 below

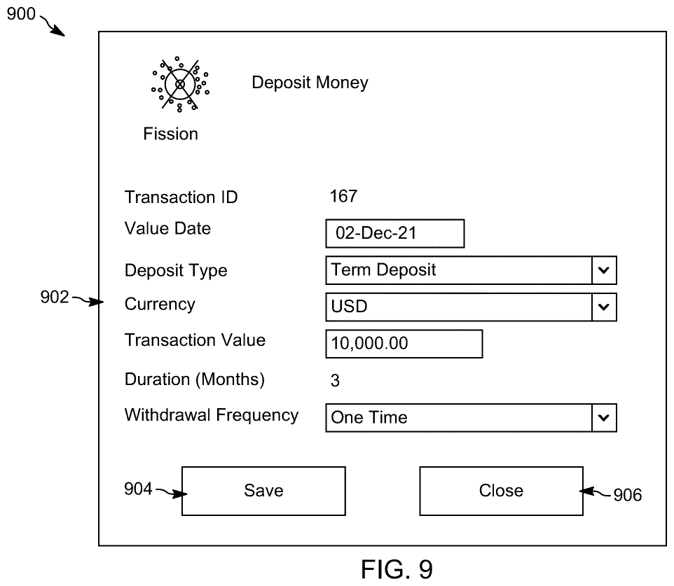

FIG. 8 illustrates an operations screen 800 presented to the customer, in accordance with an embodiment of the present disclosure. The financial data entered by the customer in FIG. 2 is displayed at the top of the operations screen 800. The operations screen 800 includes a deposit money button 802, a transactions button 804, a borrow money button 806, and a manage collaterals button 808. Upon clicking the buttons (802-808), the customer can perform the necessary banking action. These banking actions are depicted and described in FIGS. 9-14 below.

FIG. 9 illustrates a deposit screen 900 presented to the customer in which the customer deposits money, in accordance with an embodiment of the present disclosure. The deposit screen 900 is displayed on the customer device 102 when the customer clicks the deposit money button 802 of FIG. 8. The deposit screen 900 includes a deposit entering region 902, a save button 904, and a close button 906. The deposit entering region 902 includes information that is required to be entered by the customer. The information includes a transaction ID, a value date, a deposit type, currency, transaction value, duration (months), and withdrawal frequency.

As shown on the deposit screen 900, the deposit type is a term deposit, and the duration (months) is 3 months. The default duration is automatically fixed to 3 months by the system, but can be changed by the customer suit his/her requirements. While money can be deposited in a term deposit, the customer can choose a maturity schedule by defining the withdrawal frequency and even go down to the cashflows to adjust the cashflows over time based on their needs. The system uses the interest rate curves, described in FIG. 3, to calculate the necessary values based on the changes made to accommodate the customers cash needs. This can change to an annuity, inflation-linked appreciated annuity, single bullet, and the like. Once the deposit details are entered by the customer in the deposit entering region 902, the customer may click on the save button 904 for saving the entered information. A pop-up will then show on the customer device 102 screen stating that the deposit details entered by the customer have successfully been updated and saved. The customer may then click the close button 906 for closing the deposit screen 900.

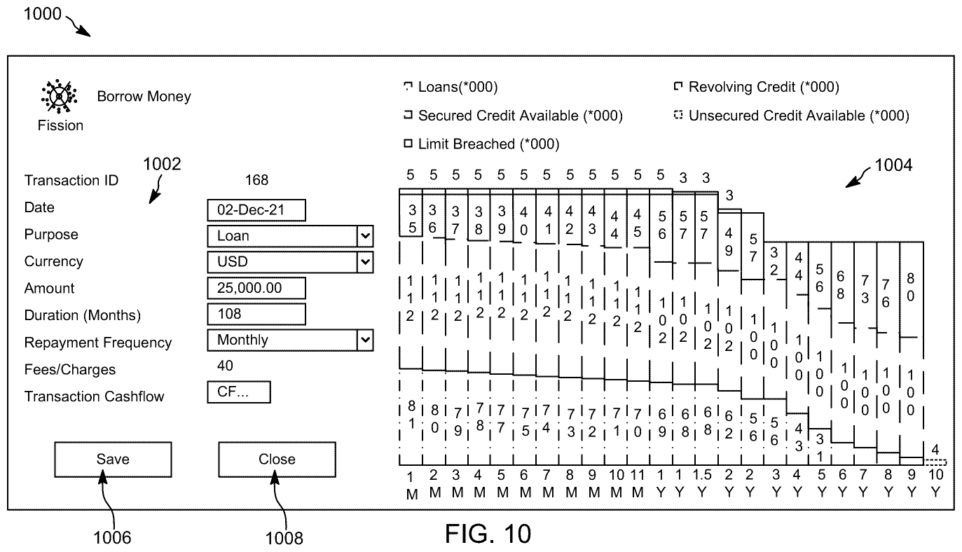

FIG. 10 illustrates a borrow screen 1000 presented to the customer in which the customer borrows money, in accordance with an embodiment of the present disclosure. The borrow screen 1000 is displayed on the customer device 102 when the customer clicks the borrow money button 806 of FIG. 8. The borrow screen 1000 includes a borrow entering region 1002, a credit position graph 1004, a save button 1006, and a close button 1008. The borrow entering region 1002 includes information that is required to be entered by the customer. The information includes a transaction ID, date, purpose, currency, amount, duration (months), repayment frequency, fees/charges, and transaction cashflow. The credit position graph 1004 is the customer credit position 408 graph curve determined by the risk profile analysis module 112 of FIG. 1. The credit position graph 1004 may be determined based on an analysis of all loans and revolving credit availed by the customer. Loans refer to medium and long term borrowing, like those to finance a home, cars, furniture, equipment, and the like. Whereas, revolving credit refers to short term financing like credit cards, overdrafts, and the like.

Money may be borrowed as a loan, as a revolving credit, or using a custom product template defined earlier. Either way, the system shows the current credit situation of the customer using the credit profile data, as shown in FIG. 4, and the customer's asset liability situation. This allows the customer to design the best possible borrowing plan while staying within the limits set by the bank. The frequency may be set to the comfort level of the customer. Further analytics may allow the system to prompt optimal options to the customer to allow them to make the most appropriate decision. The fees/charges are based on the graph curves determined and defined in FIG. 5. Once the borrowing details are entered by the customer in the borrow entering region 1002, the customer may click on the save button 1006 for saving the entered information. A pop-up will then show on the customer device 102 screen stating that the borrowing details entered by the customer have successfully been updated and saved. The customer may then click the close button 1008 for closing the borrow screen 1000.

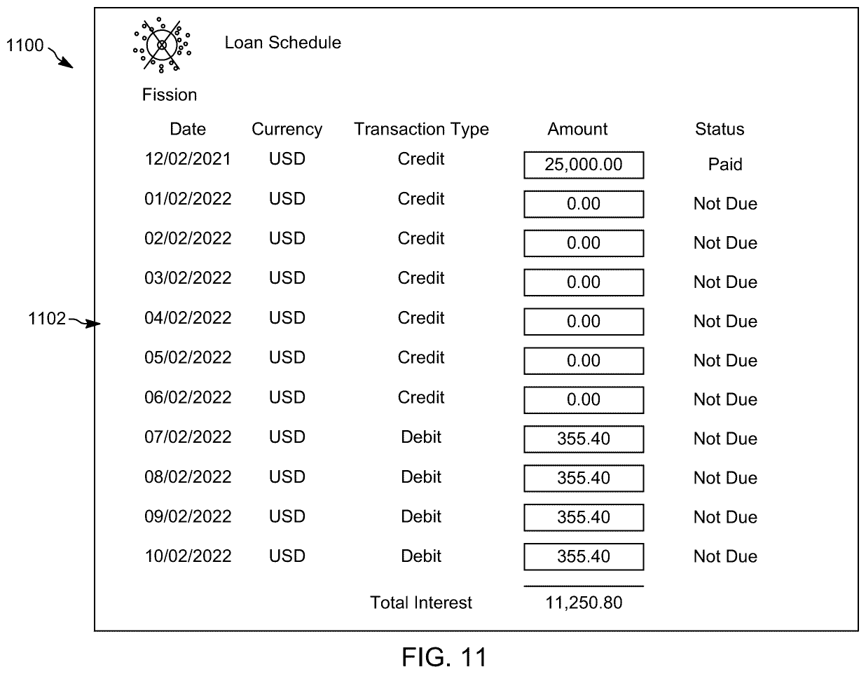

FIG. 11 illustrates a loan screen 1100 in which a loan schedule associated with the customer is presented, in accordance with an embodiment of the present disclosure. The loan screen 1100 includes a loan display screen 1102, which includes all the cashflows connected to that particular loan transaction. The loan display screen 1102 includes the date, currency, transaction type, amount, and status. The transaction type may be credit or debit, and the status indicates whether the amount is an inflow or outflow. The total interest is also calculated by the system by summing all the outflows and deduction the summations of the inflows from the same. The total interest amount to be paid is shown in yellow color at the bottom of the loan display screen 1102.

Further, the repayment schedule of the loan can be customized taking into the needs of the customers and system with ensure that the credit controls and interest rates are still maintained. This schedule can get changed mid-way as well with appropriate adjustments in fees/charges, interest rates, and the like. Further analytics may allow the system to prompt optimal options to customer to allow them to make the most appropriate decision.

The system further allows for rules to be defined at the loan level or at an individual cashflow level. For example, at a loan level, the customer can set a rule that if, at any time in the future, the market rates decrease to a point were restructuring the loan to prevalent interest rate (refinancing) gives the customer say more than $2500 of benefit, the system should automatically do so. On the other hand, the cashflows of a loan may state whether they are to follow the floating rate of interest curve or the fixed rate of interest curve. One can set these rules for one cashflow and choose to cascade automatically to all cashflows in that transaction.

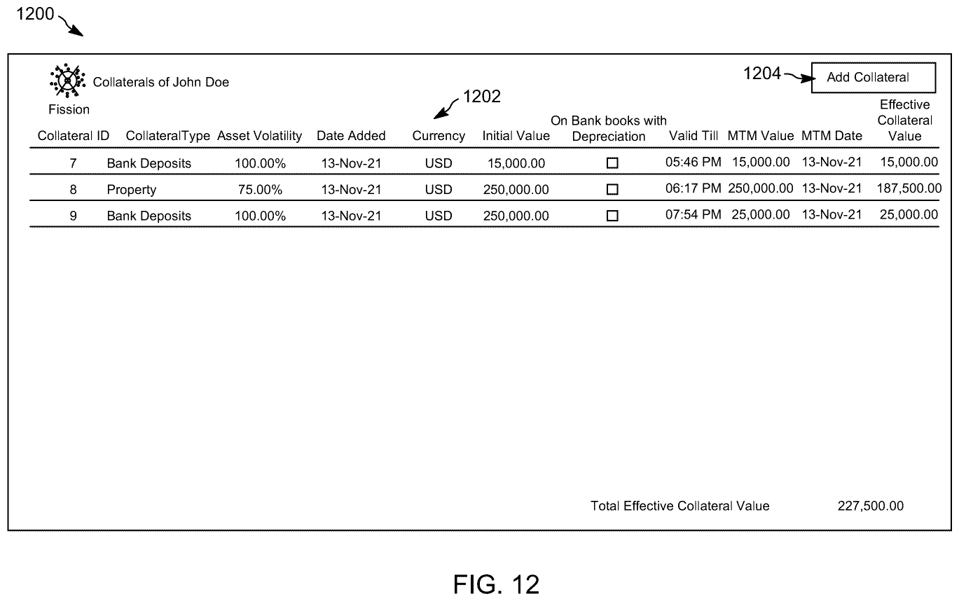

FIG. 12 illustrates a collateral management screen 1200 in which collaterals associated with the customer is presented, in accordance with an embodiment of the present disclosure. The collateral management screen 1200 is displayed on the customer device 102 when the customer clicks on the manage collaterals button 808 of FIG. 8. The collateral management screen 1200 includes a collateral display screen 1202 and an add collateral button 1204. The collateral display screen 1202 includes a collateral ID, a collateral type, asset volatility, date that the collateral has been added, currency, initial value of the collateral added, valid time, market to market (MTM) value of the collateral, MTM date, and an effective value of the collateral as may be defined by the bank from time to time.

The collaterals depicted on the collateral display screen 1202 are bank deposits and property, but could be other asset types as well as defined by the bank, like gold, securities, and the like. Based on the effective collateral value for each collateral, a total effective collateral value is determined by the system. The total effective collateral value is determined by taking a summation of each of the effective collateral values. The total effective collateral value is shown in yellow color at the bottom of the collateral display screen 1202. Further, the customer may also add collaterals to their portfolio or modify collaterals in their portfolio by clicking on the add collateral button 1204.

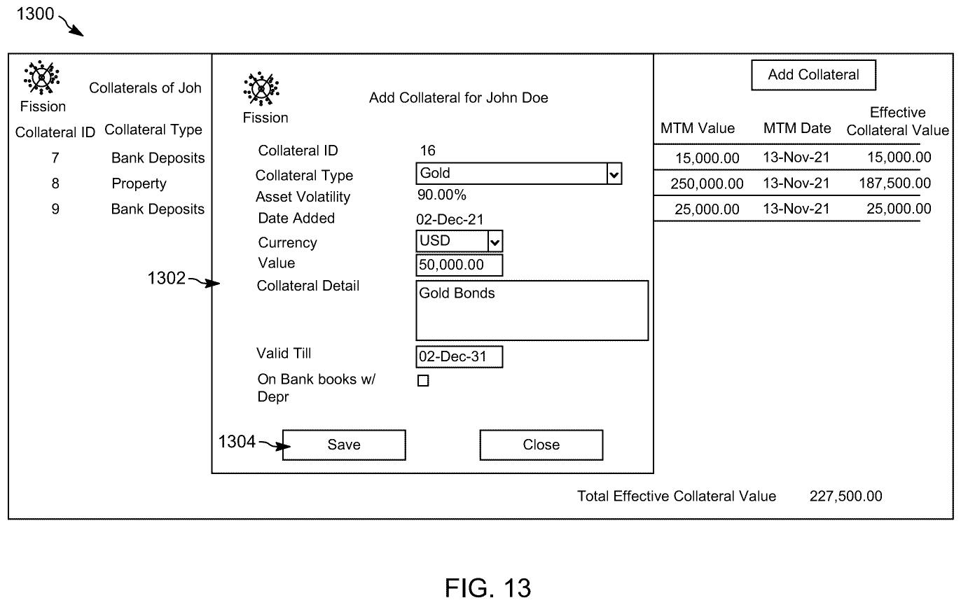

FIG. 13 illustrates an add collateral screen 1300 presented to the customer in which the customer is allowed to add and modify collaterals that they hold with the respective bank, in accordance with an embodiment of the present disclosure. The add collateral screen 1300 is displayed on the customer device 102 when the customer clicks on the add collateral button 1204 of FIG. 12. The add collateral screen 1300 includes a collateral display screen 1302, a save button 1304, and a close button. The collateral display screen 1302 includes information needed to be entered by the user while adding collaterals to their portfolio. The information includes the collateral type, currency, value, details about the collateral, and validity date of the collateral. The collateral display screen 1302 also includes the collateral ID, asset volatility, and date that the collateral has been added. These are obtained by the system based on the collateral selected by the customer for adding/modifying.

The collateral management process allows for duly adding and modifying collaterals that the customer has with the bank. For example, the collaterals may be deposits, property, securities, commodities (gold), or other kinds of assets that the bank may allow. The bank will set different parameters for valuation of these assets and such valuations/mark-to-market will be made on a periodic basis by the system and may have an impact on the credit profile of the customer. Once the collateral details are entered by the customer in the collateral display screen 1302, the customer may click on the save button 1304 for saving the entered information. A pop-up will then show on the customer device 102 screen stating that the collateral details entered by the customer have successfully been updated and saved. The customer may then click the close button for closing the collateral display screen 1302. The customer is then redirected back to the collateral management screen 1200 of FIG. 12. The customer may accordingly view the added/modified collaterals on the collateral management screen 1200.

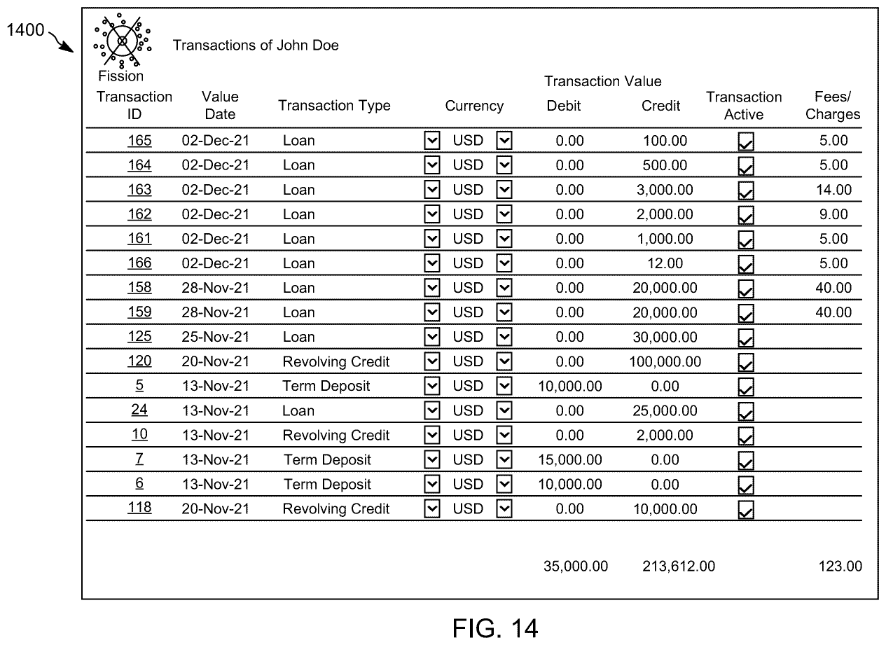

FIG. 14 illustrates a transaction screen 1400 in which a list of transactions is presented to the customer, in accordance with an embodiment of the present disclosure. The transaction screen 1400 is displayed on the customer device 102 when the customer clicks on the transactions button 804 of FIG. 8. The transaction screen 1400 presented each transaction associated with the customer in a tabular format. For each transaction, the transaction screen 1400 includes the transaction ID, value date, transaction type, currency, transaction value, transaction active, and fees/charges. The transaction types shown in the transaction screen 1400 are loans, revolving credits, term deposits. The transaction value includes a debit and credit for each transaction.

Based on the debit value and credit value for each collateral, a total debit value and a total credit value is determined by the system. The total debit value is determined by taking a summation of each debit value and the total credit value is determined by taking a summation of each credit value. The total debit value and total credit value are shown in yellow color at the bottom of the transaction screen 1400. Further, based on the fees/charges for each collateral, a total fee/charge vale to be paid is determined by the system. The total fees/charges value is determined by taking a summation of each fee/charge value. The total fees/charges value is also shown in yellow color at the bottom of the transaction screen 1400.

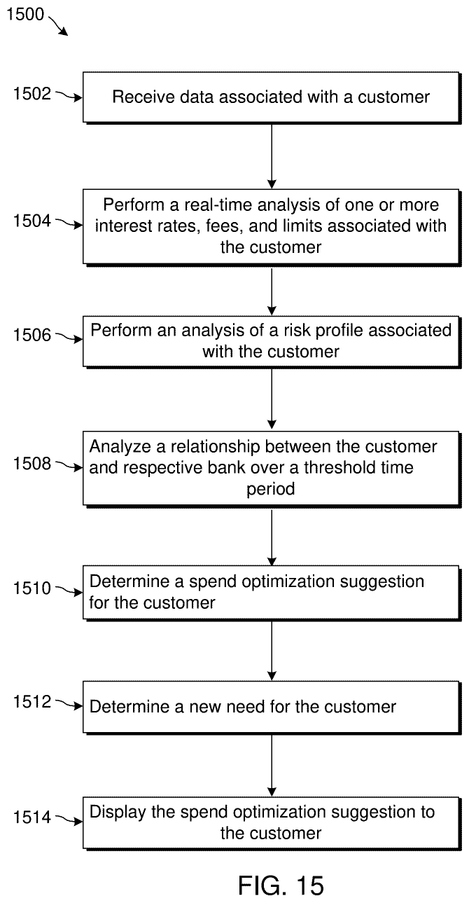

FIG. 15 illustrates a flowchart illustrating a method 1500 for determining a spend optimization suggestion for the customer, in accordance with an embodiment of the present disclosure. The steps 1502-1512 of the method may be executed using the modules 108-116 of the Server 106 of FIG. 1.

At step 1502, financial data associated with a customer is received. The financial data includes information entered by the customer at the time of registration. The financial data may be entered by the customer using the customer device 102. The financial data includes information such as an ID of the customer, name of the customer, date of birth of the customer, social security number (SSN) of the customer, current surplus income of the customer, customer segment, and an unsecured lending limit. The financial data entered by each customer is stored in the customer database 118. Further, the customer may at any point of time modify the financial details previously entered by them. These modified financial details are immediately updated and stored in the customer database 118.

At step 1504, an analysis of one or more interest rates associated with the customer is performed. The one or more interest rates analyzed include a liquid interest rate, a secured credit interest rate, an unsecured credit interest, a term interest. Each interest rate is analysed over a period (for example 5-10 years) and presented to the customer using graph curves on the customer device 102.

Liquid interest rate or liquidity refers to a degree with which an asset can be quickly brought or sold at a price close to its intrinsic/estimated value. Cash is generally considered the best liquid asset since it quickly moves in the market and can easily be converted into other assets. For instance, the interest rate analysis module 110 may determine the liquid interest rate based on ratios that measure accounting liquidity. Accounting liquidity measures an ease with which the customer can meet their financial obligations based on the liquid assets available with them, and the ability with which they can pay off debts.

Secured credit interest rate refers to situations in which customers put up an asset or collateral for any loan that they have taken. Types of secured debts may be mortgages and auto loans, in which the item being financed becomes the collateral for the financing. Unsecured credit interest rate refers to situations in which customers do not have adequate collateral to cover the borrowing of the customer. The bank may analyze the credit worthiness of the customer and provision an unsecured line to the customer that would allow for such drawdowns. The interest rate analysis module 110 analyzes the above parameters, if any, associated with the customer, and presents them on the customer device 102 using a graph curve.

Term interest rate refers to interest rates on deposits with a fixed term. For instance, the interest rate analysis module 110 first determines if any loans are outstanding for the customer, and then determines the interest for netted out surplus deposit (if any). The interest rate is determined over a period of time and presented on the customer device 102 using a graph curve.

At step 1506, an analysis of a risk profile associated with the customer is analyzed. The risk profiles analysed are a credit risk profile, an asset coverage ratio (ACR) threshold, an income coverage ratio, and a customer credit position. Each risk profile is analysed over a period (for example 5-10 years) and presented to the customer using graph curves on the customer device 102.

Credit risk is an analysis of a risk of default on a debt that may arise when a user fails to make required payments. For instance, the risk profile analysis module 112 may determine the credit risk based on prediction of a default probability, exposure, and loss rate of the customer. The default probability is a probability that the customer will default on his/her payment, exposure is an estimation of a total amount that the bank expects to collect over the loan lifetime, and loss rate refers to an estimation in how much money the bank can lose if the customer is unable to pay the loan back in time. The risk profile analysis module 112 analyzes the credit risk of the customer based on the above parameters and presents the credit risk profile analysis using a graph curve on the customer device 102.

Income coverage ratio (ICR) threshold refers to an amount of cash inflow available with the customer to meet future debt obligations. A threshold lesser than 1 indicates a net negative cash flow situation, meaning that there is not enough income to cover debt payments. For example, the customer is projected to maintain an annual income of $36,000 in the next 5-10 years and is looking to borrow money which will have an annual debt service obligation of $30,000 during this period. The Income coverage ratio for this period would be 1.2 (36000/30000). Thus, the bank might find it risky to lend with only a 1.2 coverage. The risk profile analysis module 112 analyses the ICR threshold over time based on the customer financial data and transactions and presents the same using a graph curve on the customer device 102.

Customer credit position provides a snapshot of the different credit lines that the bank has extended to the customer and the extent to which these lines have been utilized by the customer. For instance, the risk profile analysis module 112 may determine a customer credit position of the customer based on analysis of all loans and a revolving credit utilized by the customer. Loans refer to medium-and long-term borrowing, like those to finance a home, cars, furniture, equipment, and the like. Whereas revolving credit refers to short term financing like credit cards, overdrafts, and the like. The risk profile analysis module 112 analyses the customer credit position over time based on the above parameters and accordingly presents the same to the user using a graph curve (bar graph).

At step 1508, a relationship between the customer and respective bank is analyzed over a threshold time period. The threshold time is generally five years. The relationship analysis module 114 analyses factors such as assets, liabilities, a collateral value, borrowing limits, charges, and interest rates associated with the customer. These factors are presented on the customer device 102 using both values and graph curves.

At step 1510, the optimization module 116 determines an earnings-spend optimization suggestion for the customer and displays the optimization suggestions on the customer device 102. For instance, the optimization module 116 may use an artificial intelligence (AI) algorithm for determining optimization suggestions for the customer. The algorithm analyzes the financial transaction patterns of the customer along with internally and externally sources data, to determine opportunities that would allow the customer to increase their earnings or reduce their spends from their financial transactions. These could be in the form of better interest rates, fees & charges, total interest earns or paid, and the like. Such data are obtained by the interest rate analysis module 110, the risk profiles obtained by the risk profile analysis module 112, the customer and bank relationship analysis conducted by the relationship analysis module 114, and a current financial situation of the customer. The algorithm then suggests steps to be taken for the customer to optimize their earnings-expenditures, by structuring their financial transactions in a certain way.

At step 1512, the optimization module 116 determines a new need for the customer. The new need is a change in financial service for the customer based on the customer's financial state. Examples of the new need may be a new loan, a reduction of liabilities, or a new repayment option. Like the earnings-spend optimization suggestion of step 1510, the optimization module may use an AI algorithm to determine the new need. Input for the AI algorithm may include various data including the analysis of one or more interest rates associated with the customer, the analysis of the risk profile, and the analysis of the customer and the bank. In various embodiments, the new need is determined as part of the suggested steps from step 1510. For example, the suggested steps may include making changes to one or more financial services. Accordingly, the new need would comprise the one or more steps determined by the optimization module 116 that require a change to the customer's financial service rather than change in the customer's financial transactions.

At step 1514, the steps suggested by the optimization module 116 are presented to the customer in point format (numbering or bullet points) on the customer device 102. This makes it easier for the customer to understand and accordingly take the next banking action. Based on the spend optimization suggestion determined by the optimization module 116, the customer can accordingly perform the necessary banking action. For example, the banking actions include depositing money between accounts, borrowing money between accounts, manage collaterals with the bank, change the repayment schedule of loans, and the like. This will lead to an improved banking experience for the customer as well as an improved financial portfolio of the customer.

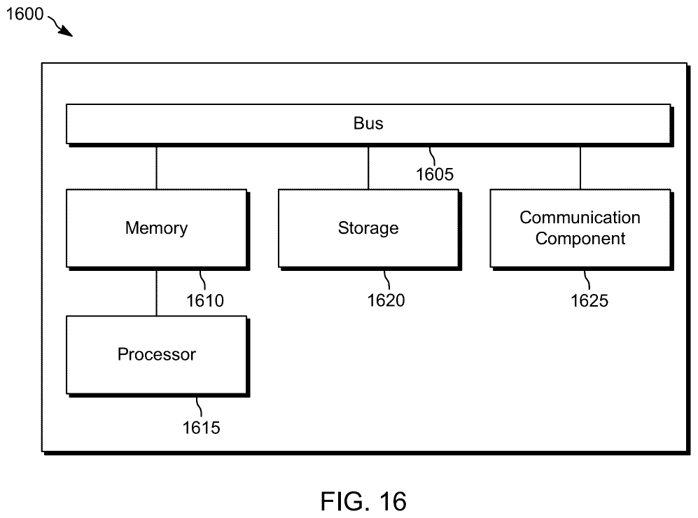

FIG. 16 is a schematic of an embodiment of a computer system 1600 that may be implemented to carry out the disclosed subject matter. As shown, the computer system 1600 includes a bus 1605, a memory 1610, a processor 1615, a storage 1620, and a communication component 1620. The bus 1605 may connect the various components of the computer system 1600. The bus 1605 may be connected to the memory 1610, which stores data that is being transmitted to the various parts of the computer system 1600 through the bus 1605. Various types of memory 1610 may be random access memory (“RAM”) and read only memory (“ROM”). The memory 1610 may transmit instructions to the processor 1115 to be executed.

The processor 1615 may process instructions that are transmitted to the processor 1615 from the memory 1610. Executed instructions may be transmitted from the memory 1610 to the various components of the computer system 1600. Various types of processors 1615 may be central processing units (“CPUs”), graphics processing units (“GPUs”), field programmable gate arrays (“FPGAs”), complex programming logic devices (“CPLDs”), and application specific integrated circuits (“ASICs”). The processor 1615 may execute instructions that are passed to the processor 1615 by the client user.

The computer system 1600 may include a storage 1620 that holds data for indefinite periods of time. The storage 1620 may continue to hold data even when the computer system 1600 is powered down. Various types of storage 1620 are magnetic tape drives, solid state drives, and flash drives. The storage 1620 may be used to store status information in the server 106. The communication component 1625 may transmit data from the memory 1610 to and from other computer systems. For example, a communication component 1625 may connect the computer system 1600 to the internet. Alternatively, the communication component 1625 may comprise an antenna that is configured to transmit and receive data. In various embodiments, the communication component 1625 may be a Bluetooth antenna, a WIFI antenna, or the like.

### Client Personalization Embodiment

The disclosed subject matter includes various embodiments such as the Client Personalization Embodiment. The Client Personalization Embodiment includes a client analysis module generator within the server. The client analysis module generator may generate a client analysis module based on client device details that are received from a client device. Various details that the client device may provide for the client analysis module generator include financial applications on the client device, transaction storage details on the client device, security hardware on the client device, input hardware on the client device, and output hardware on the client device.

The server may generate the client analysis module to tailor or customize it based on the client device and requests from the client. For example, the client may transmit various requests to the server. For instance, a request may include optimizing interest rates for one or more loans. For instance, a request may include optimizing income coverage, liability management, asset-liability alignment, or similar objectives. Accordingly, the client analysis module generator may generate a client analysis module based on the client device data details and specific requests from a customer.

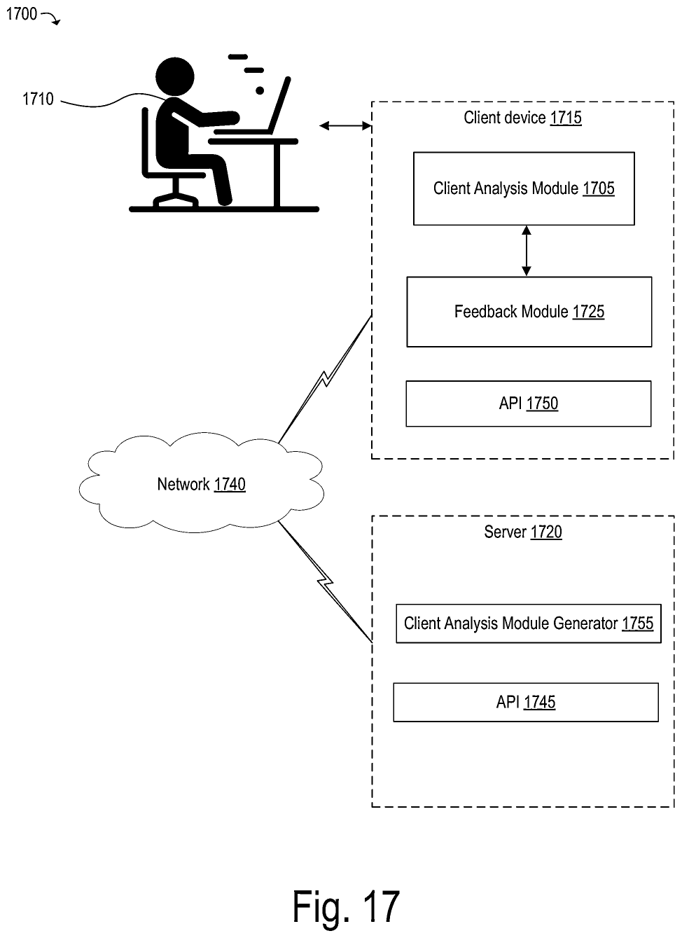

Referring to FIG. 17, FIG. 17 is a schematic 1700 of a Client Personalization Embodiment of the disclosed subject matter. The Client Personalization Embodiment includes a server 1720, communicatively coupled to a network 1740, which can connect the server 1720 to a customer database and a client device 1715. The client device 1715 is used by a user 1710. The user 1710 may be an individual, an entity, a computer system, an AI client or agent, or a combination thereof. The user 1710 may interact with the client device 1715 to request analysis for a financial situation, request analysis for a transaction, or request a suggestion for a transaction, banking action, or the like.

The network 1740 may connect the server 1720 to the client device 1715, as well as to a customer database. Various types of networks include a private network, a local area network (LAN), a wide area network (WAN), a virtual private network (VPN), a wireless network, a cloud network, a cellular network, a peer-to-peer network, and a public network.

The client device 1715 is a device used by the user 1710 to interact with one or more modules provided to the client device 1715 from the server 1720. In various embodiments, the client device 1715 may be a desktop computer system, a laptop computer system, a mobile device such as a mobile phone, a virtual machine, a cloud device, a kiosk, a console device, a television set, or similar devices.

The user 1710 may interact with the client device 1715 using various inputs. For example, the user 1710 may interact with the client device 1715 using a touchscreen. In other examples, the user 1710 may interact with the client device 1715 by speaking to it. In other examples, the user 1710 may interact with the client device 1715 using a keyboard or mouse. In various embodiments, the user 1710 may interact with the client device 1715 using a remote control. In embodiments, the user 1710 may interact with the client device 1715 using an API 1750 that is configured to operate the client device 1715. In various embodiments, the user 1710 may interact with the client device 1715 using some combination of the inputs listed herein.

The client device 1715 may include a client analysis module 1705 and a feedback module 1725. The client analysis module 1705 may be configured to provide customized analysis for the user 1710 based on the client device 1715 and specifications made by the user 1710 for analysis. The client analysis module 1705 may be generated by the server 1720 based on a request from the user 1710. For example, the user 1710 may request from the server 1720 to generate a client analysis module 1705 to perform one or more services for the user 1710. The server 1720 may then generate the client analysis module 1705 based on device data from the client device 1715 and based on the request from the user 1710. Accordingly, the client analysis module 1705 is generated by the server 1720 and transmitted to the client device 1715 based on a request from the user 1710 and one or more hardware details on the client device 1715.

For example, a hardware detail may include the type of inputs accepted by the client device 1715. Accordingly, the client analysis module 1705 would be set up with a user interface to accept the types of input that are available on the client device 1715. In another example, the client device data may include hardware data related to hardware security on the client device 1715. Accordingly, the server 1720 may generate a client analysis module 1705 that is configured to work with the hardware security that is already on the client device 1715.

Various hardware security on the client device 1715 may include biometric authentication hardware such as a fingerprint scanner, facial recognition hardware, or an iris scanner. Hardware security may include a security chip such as a Trusted Platform Module (TPM), which secures cryptographic keys, passwords, and certificates. Other examples of hardware security may include built-in encryption hardware for data protection such as CPU encryption, a secure boot mechanism, and secure memory regions. The client device 1715 may support device lock mechanisms as well as physical security features like webcam privacy shutters or physical switches for microphone and camera.

In addition to being generated based on device data on the client device 1715, the client analysis module 1705 may also be generated based on requests from the client or the user 1710. For instance, the user 1710 may send a request to optimize a loan or loans in their portfolio. The server 1720 may receive the request and cause the client analysis module generator 1755 to generate a client analysis module 1705. The client analysis module generator 1755 may customize the client analysis module 1705 based on one or more features or variables provided to it by the client device 1715. For example, the client analysis module generator 1755 may customize the client analysis module 1705 based on client device data provided to it by the client device 1715. The server 1720 may request device data using the API 1750 of the client device 1715 to determine one or more hardware features on the client device 1715 and customize the client analysis module 1705 for the client device 1715 based on these hardware features. Further, the client analysis module generator 1755 may customize the client analysis module 1705 based on the request from the user 1710. Accordingly, the client analysis module 1705 is customized based on client device hardware, the user request, or some combination thereof.

The feedback module 1725 is configured to modify the client analysis module 1705 based on changes in the client device 1715 and the needs of the user 1710. The server may generate the feedback module 1725 based on client device details provided by the client device. For example, a user 1710 who utilizes various functions in the client analysis module 1705, such as functionality related to transactions, may have this usage recorded by the feedback module 1725. Accordingly, the feedback module 1725 may communicate with the server 1720 to modify the client analysis module 1705 to increase or decrease functionality based on the user's 1710 history of use.

In another example, the feedback module 1725 may trigger a modification of the client analysis module 1705 based on one or more changes in the client device 1715. For instance, the client device 1715, due to damage or age, may lose one or more security hardware features. Accordingly, the feedback module 1725 may trigger a modification in the client analysis module 1705 to accommodate the loss of hardware security. In various embodiments, the client device 1715 may gain one or more hardware features, and the feedback module 1725 may be configured to accommodate the increased or additional hardware features. In embodiments, the feedback module 1725 may be configured to collect data based on historical user data and client device data, and communicate it to the server 1720 so that the server 1720 can determine any appropriate changes to the client analysis module 1705. In various embodiments, the feedback module 1725 may determine independently, without communicating with the server 1720, what modifications should be made to the client analysis module 1705. For instance, the feedback module 1725 may determine on its own that the client analysis module 1705 needs an increased user interface presence for transactional data related to the user's 1710 history of transactions, based on an observed increase in the user 1710 scrolling to transactional data.

The API 1750 on the client device 1715 may be configured to perform one or more actions on the client device 1715 based on an instruction or a method transmitted to the client device 1715. For example, the user 1710 may instruct the client device 1715 to perform one or more actions through the API 1750. Likewise, the server 1720 may interact with the client device 1715 through the API 1750. For instance, the server 1720 may request one or more device details from the client device 1715 by transmitting a request through the API 1750 on the client device 1715.

The server 1720 may include all of the functionality already described herein. Additionally, an embodiment of the server 1720 shown in FIG. 17 may include a client analysis module generator 1755 and an API 1745.

The client analysis module generator 1755 may generate a client analysis module 1705 based on a request sent by the user 1710 using the client device 1715. For instance, the user 1710 may send a request to optimize a loan or loans in their portfolio. The server 1720 may receive the request and cause the client analysis module generator 1755 to generate a client analysis module 1705. The client analysis module generator 1755 may customize the client analysis module 1705 based on one or more features or variables provided to it by the client device 1715. For example, the client analysis module generator 1755 may customize the client analysis module 1705 based on client device data provided to it by the client device 1715. The server 1720 may request device data using the API 1750 of the client device 1715 to determine one or more hardware features on the client device 1715 and customize the client analysis module 1705 for the client device 1715 based on these hardware features. Further, the client analysis module generator 1755 may customize the client analysis module 1705 based on the request from the user 1710. Accordingly, the client analysis module 1705 is customized based on client device hardware, the user request, or some combination thereof.

The API 1745 on the server 1720 may enable the user 1710 to interact with the server 1720. For instance, where the user 1710 is an AI agent, the AI agent may be configured to send one or more commands through the server API 1745 to cause the client analysis module generator 1755 to generate a client analysis module 1705. In various examples, the user 1710 may interact with the server API 1745 to perform one or more analyses, such as those described herein, for the user 1710.

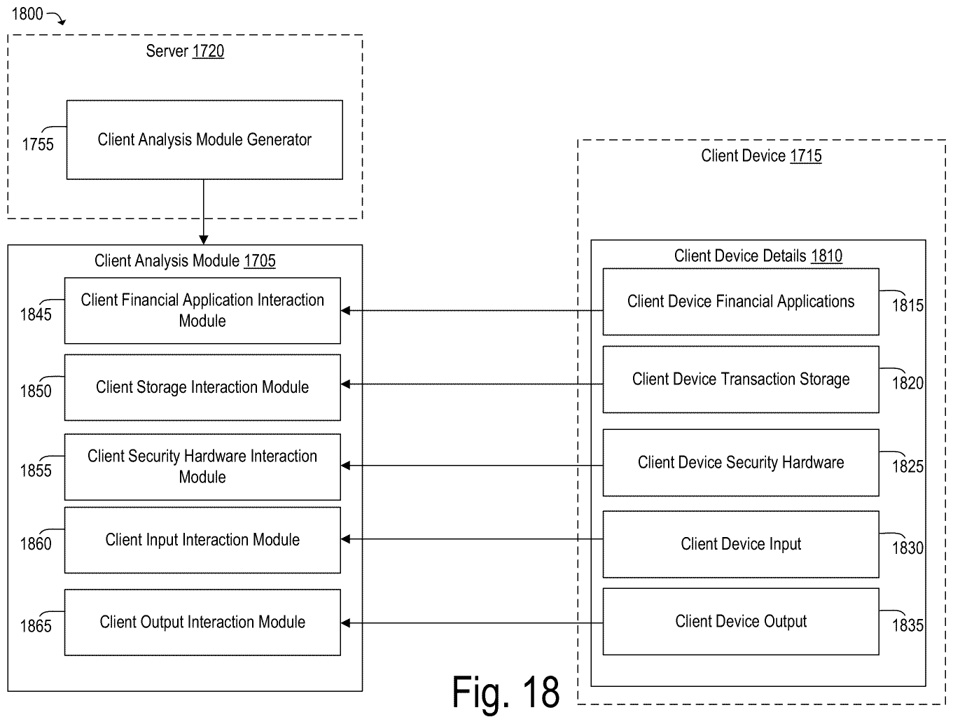

Referring to FIG. 18, FIG. 18 is a schematic 1800 showing an embodiment of the client analysis module generator 1755 and the client analysis module 1705 interacting with a client device 1715. As discussed above, the client analysis module generator 1755 in the server 1720 may generate a client analysis module 1705 based at least partially on the client device details 1810 provided to the client analysis module generator 1755 from the client device 1715. Likewise, the feedback module may be configured to be generated by the server based at least partially on the client device details 1810.

The client analysis module generator 1755 may be configured to generate the client analysis module 1705 based on a variety of client device details. For example, the client analysis module generator 1755 may generate the client analysis module 1705 based on the processor 1615 and memory 1610 capacity in the client device 1715. In the exemplary embodiment of the interaction between the client device 1715 and the client analysis module generator 1755 shown in FIG. 18, the client analysis module generator 1755 collects client device details for client device financial applications 1815, client device transaction storage 1820, client device security hardware 1825, client device input 1830, and client device output 1835.

The client device financial applications 1815 may include any applications that are installed on the client device 1715 or connected to the client device 1715, such as through a cloud subscription. Various types of financial applications that are installed or otherwise operate on the client device 1715 include banking applications, investment platforms, budgeting and expense tracking applications, loan management applications, tax preparation software, payment and wallet applications, accounting software, credit score management tools, insurance management platforms, and retirement and savings planning tools.

Based on the various financial applications on the client device 1715, the client analysis module generator 1755 may generate a client analysis module 1705 with a client financial application interaction module 1845 that is customized to work with the specific client device financial applications 1815 found on the client device 1715. An example of a customization on the client analysis module 1705 may include a user interface that is organized to accommodate the various client device financial applications 1815 found on the client device 1715, as provided to the client analysis module generator 1755 by the client device 1715.

Another example of customization on the client analysis module 1705 for the client financial application interaction module 1845 may include one or more functions that are configured to operate the financial applications specified by the client device financial applications 1815.

The client device transaction storage 1820 in the client device details 1810 may provide various transaction details that are stored on the client device 1715. For example, various platforms such as Android may collect and store transaction details of the user 1710. The client device transaction storage 1820 may be transmitted to the client analysis module generator 1755 to generate a client analysis module 1705 with a client storage interaction module 1850 that is customized to work with the client device transaction storage 1820. For example, the generated client storage interaction module 1850 may be customized by the client analysis module generator 1755 to work with the platform that stores transaction details on the client device 1715. For instance, the client device 1715 may store transaction details on the Google platform. The client storage interaction module 1850 may be configured to interact with the Google platform on the client device 1715. Additionally, the client storage interaction module 1850 may be configured to provide analysis services for the user 1710.

The client device security hardware 1825 represents all the security-related hardware on the client device 1715. As referenced above, the various security hardware may include, but is not limited to, biometric authentication hardware, Trusted Platform Module (TPM), secure enclave or secure element, hardware security keys, encryption hardware, secure boot mechanism, secure memory, tamper-resistant hardware, mobile device management (MDM) systems, device lock mechanisms, hardware root of trust, webcam privacy shutters, and physical switches for microphone and camera access. The client analysis module generator 1755 may collect the client device security hardware 1825 information to generate the client security hardware interaction module 1855. The client security hardware interaction module 1855 may be configured to collect data from and/or operate the various hardware security features on the client device 1715 that were provided in the client device security hardware 1825.

In an example of use, the client security hardware interaction module 1855 may be configured by the client analysis module generator 1755 to interact with the hardware encryption on the client device 1715 to encrypt various financial data. For instance, the client security hardware interaction module 1855 may be configured to use hardware encryption provided on an Intel CPU in the client device 1715.

Client device input 1830 may include any input hardware or input capability on the client device 1715. Advanced examples of input may include a touchscreen, keyboard and mouse, joystick, remote control, microphone, camera, and similar input devices. The client analysis module generator 1755 may collect the client device input 1830 to generate the client input interaction module 1860. The client input interaction module 1860 may be configured to operate on the client device 1715 using the input provided by the client device input 1830. For example, if the client device input 1830 is limited to a camera, the client input interaction module 1860 may configure the user interface on the client analysis module 1705 to accept gesture input.

The client device output 1835 is a client device detail that may include any output hardware functionality on the client device 1715. Examples of output hardware on the client device 1715 may include a device screen, speakers, and haptic feedback. The client analysis module generator 1755 may collect the client device output 1835 to generate the client output interaction module 1865, customizing it to work with the specific hardware on the client device 1715. In an example of use, the user interface on the client analysis module 1705 may be configured to work with the screen size and shape on the client device 1715.

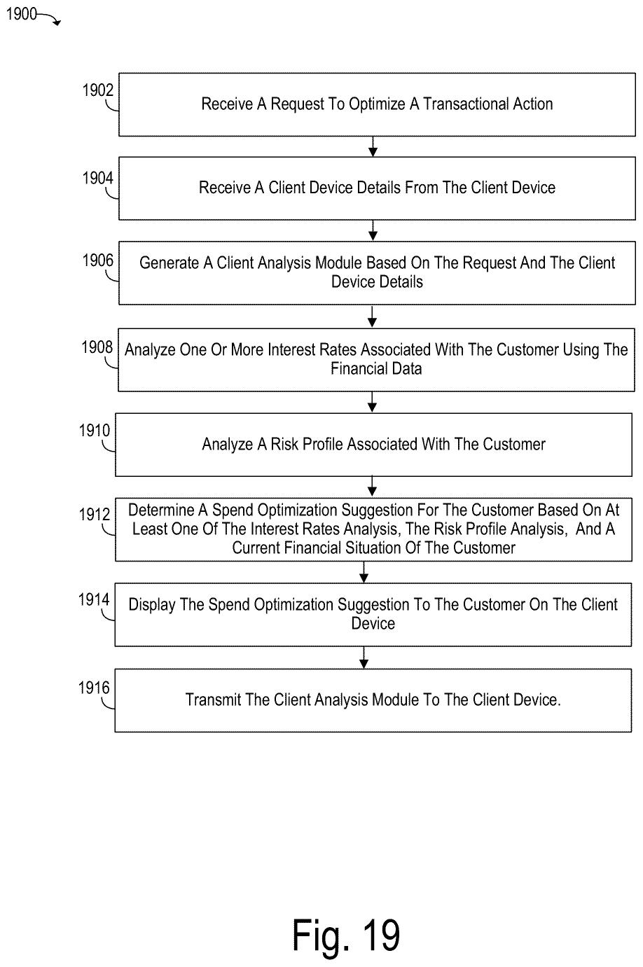

Referring to FIG. 19, FIG. 19 is a flow diagram of the Client Personalization Embodiment of the disclosed subject matter. The Client Personalization Embodiment is configured to transmit a customized client analysis module 1705 to a client device 1715, based on one or more details of the client device 1715, to provide a financial service for the client.

The customized client analysis module 1705 may be tailored both based on the client device hardware and on requests from a user 1710. For example, the customized client analysis module 1705 may be configured to service various loan payment schedules based on requests from the user 1710. The client analysis module 1705 may also be further customized based on hardware on the client device 1715. For instance, the client device 1715 may include one or more security features or client device security hardware 1825, and the client analysis module 1705 may be configured to utilize the specific client device security hardware 1825 on the client device 1715.

At step 1902 of the process 1900, the server 1720 may receive a request to optimize a transactional action. The transactional action may include any banking action, financial action, or any other action involving holding, trading, spending, or saving a security. The request may be initiated by a user 1710 and transmitted through the client device 1715 used by the user 1710, via a network 1740, to the server 1720. The request may be broad in scope or specific in nature. For instance, if the request is broad in scope, the server 1720 may generate a client analysis module 1705 with broad service functionality. Alternatively, if the user 1710 requests a specific service to optimize a transactional action, the generated client analysis module 1705 will be customized accordingly to accommodate the user's 1710 request.

At step 1904 of the process 1900, the server 1720 may receive client device details 1810 from the client device 1715. The client device details 1810 may include various client device hardware parameters, such as financial applications that are installed or otherwise operate on the client device 1715, transactions stored on the client device 1820, client device security hardware 1825, client device input 1830, and client device output 1835.

At step 1906 of the process 1900, the server 1720 may generate a client analysis module 1705 based on the request and the client device details 1810. The client analysis module 1705 may be generated by the client analysis module generator 1755 on the server 1720. The client analysis module 1705 may incorporate the specific request made by the user 1710 as well as the client device details 1810 provided by the client device 1715. A variety of aspects in the client analysis module 1705 may be adjusted based on the request and client device details 1810. For example, the user interface of the client analysis module 1705 may be modified based on parameters in the hardware or the request from the client or user 1710. In another example, any functionality to optimize transactional actions on the client analysis module 1705 may be at least partly based on the request from the user 1710 and/or the client device details 1810.

At step 1908 of the process 1900, the client analysis module 1705 may be configured to analyze one or more interest rates associated with the customer using the financial data. The analysis of the one or more interest rates may be tailored based on the client request. For instance, if the client requested a specific aspect of the analysis, the analysis of the one or more interest rates would be minimized. The client analysis module 1705 will be configured to perform the analysis of the one or more interest rates based on the scope of the request. For instance, the user 1710 may request that a multitude of interest rates be configured to be as equal as possible over a period of time. The client analysis module 1705 could be configured accordingly. For example, the client analysis module 1705 may be configured to provide for using hardware encryption on the client device 1715 when analyzing the interest rates.

At step 1910 of the process 1900, the client analysis module 1705 may be configured to analyze a risk profile associated with the user 1710. The analysis of the risk profile may be modified based on the request from the user 1710. For example, the user 1710 may specify that the client analysis module 1705 be configured to adopt an aggressive approach to the analysis.

At step 1912 of the process 1900, the client analysis module 1705 may determine a spend optimization suggestion for the customer based on at least one of the interest rate analysis, the risk profile analysis, and the current financial situation of the user 1710. The spend optimization suggestion may be tailored based on the request made by the user 1710 and client device details 1810 provided by the client device 1715. For example, the spend optimization suggestion may be configured to operate with one or more financial applications determined to be on the client device 1715. Further, the scope of the spend optimization may be partially based on details of the request from the user 1710. For instance, the user 1710 may make a request to minimize spending over a specific period and then maximize spending over a different period. The spend optimization suggestion could partially reflect that request as well.

At step 1914 of the process 1900, the client analysis module 1705 may display the spend optimization suggestion to the user 1710 on the client device 1715. The client analysis module 1705 may be customized to display the spend optimization suggestion based on the client device 1715. The client analysis module 1705 may be configured to display the spend optimization suggestion based on the size of the screen on the client device 1715. Further, the client analysis module 1705 may be configured to produce an audio version of the spend optimization suggestion if the client device 1715 does not have a screen or if the screen is small.

At step 1916 of the process 1900, the server 1720 may transmit the client analysis module 1705 to the client device 1715. The client analysis module 1705 may be generated by the client analysis module generator 1755 on the server 1720. After transmitting the client analysis module 1705 to the client device 1715, the feedback module 1725 may collect data from the client device 1715 and transmit it to the server 1720 to make further modifications. For example, if the hardware profile of the client device 1715 changes, the feedback module 1725 may provide necessary information to the server 1720 to modify the client analysis module 1705 accordingly.

The system and method described herein above has several technical advantages. The system and method described herein simplifies banking by allowing financial institutions to provide a uniquely customized solution to their customers in line with their exact requirements, by providing hyper-personalization not at the front-end but by removing the product silos. This helps the banks and financial institutions to uniquely understand their customers by atomizing the customer needs into a set of cashflows, each with its own risk (credit & market), and triggers/conditions (e.g., timelines, in case valuation reaching a certain number, in case risk of cashflow breaches a certain number, any predefined constraints.

The system and method described herein further aggregates the customers' entire financial portfolio to deliver the best pricing to each customer, while enabling the bank to analyze the risk vs profitability at an individual customer level. The bank analyzes factors such as interest rates, risk profiles, and a financial relationship between the customer and bank over a time period (for example five to ten years). These analyzed factors are presented to the customer on their respective device in the form of graph curves. Such dashboards/graph curves enable the customers to know how they are doing financially across all financial assets/liabilities. Risk management is simplified as products are deconstructed into their asset/liability positions and cashflows. The bank can establish various risk curves and then use it with the asset/liability positions and cashflows to arrive at more accurate risk calculations. The above curves would also allow for better pricing.

Further, the system and method described herein suggests steps that customers may take to optimize their financial portfolio. The optimization-based algorithm used by the system helps the banks take holistic decisions on the customer. These steps are presented to the customer in point format (numbering or bullet points) on their respective device. Such presentation makes it easier for the customer to understand and accordingly take the next banking action. For example, the banking actions may include depositing money between accounts, borrowing money between accounts, and manage collaterals with the bank. This thus will lead to an improved banking experience for the customer as well as an improved financial portfolio of the customer.

The foregoing description of the embodiments has been provided for purposes of illustration and not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A system for providing a customized financial solution, comprising:
a server configured to receive a financial data associated with a customer;
a network communicatively coupling a client device to the server; and
the server comprising a processor and a memory, the memory stores computer-executable instructions that, if executed, cause the processor to:
receive a request to optimize a transactional action;
receive a client device details from the client device;
generate a client analysis module based on the request and the client device details, the client analysis module configured to cause the client device to:
analyze one or more interest rates associated with the customer using the financial data;
analyze a risk profile associated with the customer; and
determine a spend optimization suggestion for the customer based on at least one of the interest rates analysis, the risk profile analysis, and a current financial situation of the customer; and
display, on the client device, the spend optimization suggestion to the customer;
transmit the client analysis module to the client device.

2. The system of claim 1, wherein the instructions further cause the processor to:
generate a feedback module, the feedback module configured to:
store client data that is generated subsequent to generating the feedback module;
transmit the stored client data to the server; and
receive, from the server, modification instructions based on the client data, the modification instruction configured to modify one or more modules on the client device;
transmit the feedback module to the client device.

3. The system as claimed in claim 1, wherein the server is further configured to analyze a relationship between the customer and a respective bank over a threshold time period that is determined based on at least one behavior of the customer, account type, and preference of the customer.

4. The system as claimed in claim 1, wherein the processor is further configured to adjust the spend optimization suggestion based on real time updates from external financial data sources, including market interest rates, customer transactions, and macroeconomic indicators, and provide periodic re-evaluations of the suggestion.

5. The system as claimed in claim 3, wherein the processor is further configured to determine a new need of the customer based on at least one of the interest rates analysis, the risk profile analysis, the relationship analysis, and a current financial situation of the customer.

6. The system as claimed in claim 1, wherein the one or more interest rates comprises at least one of a liquid interest rate, a secured credit interest rate, an unsecured credit interest, a term interest, and a combination thereof.

7. The system as claimed in claim 1, wherein the processor is further configured to present the interest rates analysis and the risk profile analysis to the customer using one or more graph curves.

8. The system as claimed in claim 1, wherein the processor is further configured to periodically update the one or more interest rates based on changes in market rates, a credit risk of the customer, financial data updates associated with the customer, and an asset-liability situation of the customer.

9. The system as claimed in claim 1, wherein the risk profile analyzed comprises at least one of a credit risk profile, a asset coverage ratio (ACR) threshold, an income coverage ratio, and a customer credit position.

10. The system as claimed in claim 1, wherein the risk profile is periodically updated based on at least one of financial information of the customer, financial transactions, changes in assets and liabilities associated with the customer, and external information associated with the customer.

11. The system as claimed in claim 1, wherein the processor is further configured to:
determine one or more charges associated with the customer;
analyze the one or more charges, wherein the one or more charges analyzed comprise at least one of liquidity charges, loan charges, revolving credit charges, cashflow restructure charges, and a combination thereof; and
present the one or more charges analyzed to the customer using graph curves.

12. The system as claimed in claim 1, wherein the processor is further configured to adjust the spend optimization suggestion based on real time updates from external financial data sources, including market interest rates, customer transactions, and macroeconomic indicators, and provide periodic re-evaluations of the suggestion.

13. The system as claimed in claim 1, wherein the processor is further configured to determine a new need of the customer based on at least one of the interest rates analysis, the risk profile analysis, and a current financial situation of the customer.

14. A method for providing a customized financial solution, comprising:
receiving a request from a customer to optimize a transactional action;
receiving a client device details from the client device;
generating a client analysis module based on the request and the client device details, the client analysis module configured to cause the client device to:
analyze one or more interest rates associated with the customer;
analyze a risk profile associated with the customer; and
determine a spend optimization suggestion for the customer based on at least one of the interest rates analysis, the risk profile analysis, and a current financial situation of the customer; and
display, on the client device, the spend optimization suggestion to the customer;
transmitting the client analysis module to the client device.

15. The method as claimed in claim 14, further comprising:
generating a feedback module, the feedback module configured to:
store client data that is generated subsequent to generating the feedback module;
transmit the stored client data to a server; and
receive, from the server, modification instructions based on the client data, the modification instruction configured to modify one or more modules on the client device;
transmitting the feedback module to the client device.

16. The method as claimed in claim 14, further comprising analyzing a relationship between the customer and a respective bank over a threshold time period that is determined based on at least one behavior of the customer, account type, and preference of the customer.

17. The method as claimed in claim 14, wherein the one or more interest rates comprises at least one of a liquid interest rate, a secured credit interest rate, an unsecured credit interest, a term interest, and a combination thereof.

18. The method as claimed in claim 14, further comprising adjusting the spend optimization suggestion based on real time updates from external financial data sources, including market interest rates, customer transactions, and macroeconomic indicators, and provide periodic re-evaluations of the suggestion.

19. A computer readable storage medium having data stored therein representing software executable by a computer system, the software comprising instructions that, when executed, cause the computer readable storage medium to perform:
receiving a request from a customer to optimize a transactional action;
receiving a client device details from the client device;
generating a client analysis module based on the request and the client device details, the client analysis module configured to cause the client device to:
analyze one or more interest rates associated with the customer;
analyze a risk profile associated with the customer; and
determine a spend optimization suggestion for the customer based on at least one of the interest rates analysis, the risk profile analysis, and a current financial situation of the customer; and
display, on the client device, the spend optimization suggestion to the customer;
transmitting the client analysis module to the client device.

20. The computer readable storage medium as claimed in claim 19, wherein the instructions further cause the computer readable storage medium to perform:
generating a feedback module, the feedback module configured to:
store client data that is generated subsequent to generating the feedback module;
transmit the stored client data to the computer system; and
receive, from the computer system, modification instructions based on the client data, the modification instruction configured to modify one or more modules on the client device;
transmitting the feedback module to the client device.
